(19) United States
(12) Patent Application Publication
(10) Pub. No.: US 2024/0195562 A1
(43) Pub. Date: Jun. 13, 2024

(54) METHOD AND DEVICE IN NODES USED FOR WIRELESS COMMUNICATION

(71) Applicants: Qi JIANG, Shanghai (CN); Xiaobo ZHANG, Shanghai (CN)

(72) Inventors: Qi JIANG, Shanghai (CN); Xiaobo ZHANG, Shanghai (CN)

(73) Assignee: SHANGHAI LANGBO COMMUNICATION TECHNOLOGY COMPANY LIMITED, Shanghai, OT (CN)

(21) Appl. No.: 18/581,399

(22) Filed: Feb. 20, 2024

Related U.S. Application Data
(63) Continuation of application No. PCT/CN2022/110799, filed on Aug. 8, 2022.

(30) Foreign Application Priority Data
Aug. 20, 2021 (CN) 202110959856.1
Aug. 26, 2021 (CN) 202110987008.1

(51) Int. Cl. H04L 5/00

(52) U.S. Cl. CPC H04L 5/0048; H04L 5/0007

(57) ABSTRACT

A node first receives a first signaling, the first signaling is used to indicate a first reference signal resource; then receives or transmits a first signal in a first time-frequency resource set, the first reference signal resource is used to determine spatial parameters of the first signal; the first signaling is used to indicate the first time-frequency resource set; the first signaling indicates the first reference signal resource from K1 candidate reference signal resources; a target reference signal resource set comprises the K1 candidate reference signal resources; time-domain resources occupied by the first time-frequency resource set are used to determine the target reference signal resource set from M1 reference signal resource sets. It improves the manner in which the TCI is determined, hence improves the manner in which beamforming is transmitted in a spectrum configuration based on a flexible duplex mode or variable link direction to optimize system performance.

### CROSS REFERENCE TO RELATED APPLICATIONS

This application is the continuation of an international patent application No. PCT/CN2022/110799, filed on Aug. 8, 2022, and claims the priority benefit of Chinese Patent Application No. 202110959856.1, filed on Aug. 20, 2021, and claims the priority benefit of Chinese Patent Application No. 202110987008.1, filed on Aug. 26, 2021, the full disclosure of which is incorporated herein by reference.

### BACKGROUND

### Technical Field

The present application relates to transmission methods and devices in wireless communication systems, and in particular to a transmission scheme and device for flexible transmission direction configuration in wireless communications.

### Related Art

Application scenarios of future wireless communication systems are becoming increasingly diversified, and different application scenarios have different performance demands on systems. In order to meet different performance requirements of various application scenarios, it was decided at 3rd Generation Partner Project (3GPP) Radio Access Network (RAN) #72th plenary that a study on New Radio (NR), or what is called Fifth Generation (5G) shall be conducted. The work item of NR was approved at 3GPP RAN #75th plenary to standardize NR. A Study Item (SI) and a Work Item (WI) of NR Rel-17 was decided to start at 3GPP RAN #86-th plenary, and it is anticipated that an SI and WI of NR Rel-18 will be approved at 3GPP RAN #94e-th plenary.

In new radio technology, enhanced Mobile BroadBand (eMBB), Ultra-reliable and Low Latency Communications (URLLC), and massive Machine Type Communications (mMTC) are the three main application scenarios. In NR Rel-16 system, the main difference between Long-Term Evolution (LTE) and LTE-A frame structures is that symbols in a slot can be configured as Downlink, Uplink and Flexible. For symbols configured as “Flexible”, the terminal will receive Downlink on the symbol, and the symbol can also be used for Uplink scheduling. The above methods are more flexible than LTE and LTE-A systems.

### SUMMARY

In existing NR systems, spectrum resources are statically divided into FDD spectrum and TDD spectrum. For the TDD spectrum, both the base station and User Equipment (UE) operate in half-duplex mode. This half-duplex mode avoids self-interference and can mitigate the impact of Cross Link interference, but also brings about a decrease in resource utilization and an increase in latency. For these problems, supporting flexible duplex mode or variable link orientation (uplink or downlink or flexible) on the TDD spectrum or FDD spectrum becomes a possible solution.

However, as the uplink and downlink configurations in the system become more flexible, especially for the base station, both downlink and uplink transmissions are performed on different frequency bands in a same slot. In this scenario, the interference environment faced by beam forming-based transmission will become more complex, and the traditional TCI (Transmission Configuration Indication) configuration and selection method need to be redesigned.

The present application discloses a solution to the problem of supporting the configuration of link direction in flexible duplex mode. It should be noted that in the description of the application, flexible duplex mode is only used as a typical application scenario or example; the application is also applicable to other scenarios confronting similar problems (such as scenarios where link direction changes, or other scenarios that support multi-level configuration of the transmission direction, or the base station or UE with stronger capabilities, such as scenarios supporting full duplex on a same frequency, or for different application scenarios, such as eMBB and URLLC), where similar technical effects can be achieved. Additionally, the adoption of a unified solution for various scenarios, including but not limited to scenarios of eMBB and URLLC, contributes to the reduction of hardware complexity and costs. If no conflict is incurred, embodiments in a first node in the present application and the characteristics of the embodiments are also applicable to a second node, and vice versa. Particularly, for interpretations of the terminology, nouns, functions and variants (if not specified) in the present application, refer to definitions given in Technical Specification (TS) 36 series, TS38 series and TS37 series of 3GPP specifications.

The present application provides a method in a first node for wireless communications, comprising:
receiving a first signaling, the first signaling being used to indicate a first reference signal resource; and
receiving a first signal in a first time-frequency resource set, the first reference signal resource being used to determine spatial parameters of the first signal;
herein, the first signaling is used to indicate the first time-frequency resource set; the first reference signal resource is one of K1 candidate reference signal resources, K1 is a positive integer greater than 1, and the first signaling indicates the first reference signal resource from the K1 candidate reference signal resources; a target reference signal resource set comprises K1 candidate reference signal resources, and the target reference signal resource set is one of M1 reference signal resource sets, where M1 is a positive integer greater than 1; time-domain resources occupied by the first time-frequency resource set are used to determine the target reference signal resource set from the M1 reference signal resource sets.

The present application provides a method in a first node for wireless communications, comprising:
receiving a first signaling, the first signaling being used to indicate a first reference signal resource; and
transmitting a first signal in a first time-frequency resource set, the first reference signal resource being used to determine spatial parameters of the first signal;
herein, the first signaling is used to indicate the first time-frequency resource set; the first reference signal resource is one of K1 candidate reference signal resources, K1 is a positive integer greater than 1, and the first signaling indicates the first reference signal resource from the K1 candidate reference signal resources; a target reference signal resource set comprises K1 candidate reference signal resources, and the target reference signal resource set is one of M1 reference signal resource sets, where M1 is a positive integer greater than 1; time-domain resources occupied by the first time-frequency resource set are used to determine the target reference signal resource set from the M1 reference signal resource sets.

In one embodiment, one technical feature of the above method is in: establishing a connection between a TCI or an SRI (Sounding Reference Signal Resource Indicator) indicated by the first signaling and time-domain resources occupied by the first time-frequency resource set; when the interference situation corresponding to time-domain resources occupied by the first time-frequency resource set changes, one reference signal resource set from the corresponding M1 reference signal resource sets can be used as the target reference signal resource set, thereby reducing interference and ensuring system performance.

In one embodiment, another technical feature of the above method is in: when the first node receives the first signal and time-domain resources occupied by the first time-frequency resource set are configured as “F” (Flexible), this means that the base station in the time-domain resources occupied by the first time-frequency resource set may have scheduled a terminal other than the first node for uplink transmission, and a TCI adopted by the first signal should avoid interference from the uplink beam; relatively, time-domain resource occupied by the first time-frequency resource set are configured as “D” (Downlink), the above mentioned beam interference from the uplink will not be present because the base station will not schedule uplink transmissions in time-domain resources.

In one embodiment, another technical feature of the above method is in: when the first node transmits the first signal, and time-domain resources occupied by the first time-frequency resource set are configured as “F” (Flexible), this means that the base station in the time-domain resources occupied by the first time-frequency resource set may have scheduled a terminal other than the first node for downlink reception, and an SRI adopted by the first signal should avoid interference with the downlink beam; relatively, time-domain resource occupied by the first time-frequency resource set are configured as “U” (Uplink), the above mentioned beam interference for the downlink will not be present because the base station will not schedule downlink transmissions in the time-domain resources.

According to one aspect of the present application, the M1 reference signal resource sets comprise a first reference signal resource set and a second reference signal resource set, and time-domain resources occupied by the first time-frequency resource set comprise a first symbol set; when a format adopted by a symbol in the first symbol set is a first format, the target reference signal resource set is the first reference signal resource set; when a format adopted by a symbol in the first symbol set is a second format, the target reference signal resource set is the second reference signal resource set; the first format and the second format are different.

In one embodiment, one technical feature of the above method is in: a target reference signal resource set is determined based on a format of a symbol comprised in time-domain resources occupied by the first time-frequency resource set, and then different reference signal resource sets are selected as a target reference signal resource sets for different formats to reduce interference and ensure the system performance.

According to one aspect of the present application, the M1 reference signal resource sets comprise a first reference signal resource set and a second reference signal resource set, and time-domain resources occupied by the first time-frequency resource set belong to a first time unit; when the first time unit is a time unit in a first time unit set, the target reference signal resource set is the first reference signal resource set; when the first time unit is a time unit in a second time unit set, the target reference signal resource set is the second reference signal resource set; a format of any time unit in the first time unit set is different from a format of any time unit in the second time unit set.

In one embodiment, one technical feature of the above method is in: a target reference signal resource set is determined based on a format of a slot to which time-domain resources occupied by the first time-frequency resource set belong, and then different reference signal resource sets are selected as a target reference signal resource set for different formats to reduce interference and ensure the system performance.

According to one aspect of the present application, comprising:
receiving a first information block;
herein, the first information block is used to indicate a format adopted by a symbol comprised in the time-domain resources occupied by the first time-frequency resource set.

According to one aspect of the present application, comprising:
receiving a second information block;
herein, the second information block is used to indicate the M1 reference signal resource sets.

According to one aspect of the present application, transmit power of the first signal is equal to a first power value, the first power value is not greater than a first threshold, the first threshold is one of M2 candidate thresholds, time-domain resources occupied by the first time-frequency resource set are used to determine the first threshold from the M2 candidate thresholds; M2 is a positive integer greater than 1.

According to one aspect of the present application, transmit power of the first signal is equal to a first power value, the first power value is linearly correlated with a target power value, the target power value is equal to one of M3 candidate power values, and time-domain resources occupied by the first time-frequency resource set are used to determine the target power value from the M3 candidate power values, M3 is a positive integer greater than 1.

In one embodiment, one technical feature of the above two methods is in: when the first node receives the first signal and time-domain resources occupied by the first time-frequency resource set are configured as “F”, which means that the base station in the time-domain resources occupied by the first time-frequency resource set may have scheduled a terminal other than the first node for uplink transmission, therefore, a transmit power value of the first signal should take into account the interference from the uplink beam and the power value needs to be raised; relatively, time-domain resource occupied by the first time-frequency resource set are configured as “D”, the above mentioned interference from the uplink will not be present because the base station will not schedule uplink transmissions in the time-domain resources.

In one embodiment, another technical feature of the above two methods is in: furthermore, a connection is established between transmit power of the first signal and time-domain resources occupied by the first time-frequency resource set; when the first node transmits the first signal, and time-domain resources occupied by the first time-frequency resource set are configured as “F” (Flexible), this means that the base station in the time-domain resources occupied by the first time-frequency resource set may have scheduled a terminal other than the first node for downlink reception, furthermore, transmit power value of the first signal should be reduced to avoid interference with the downlink reception of other terminals; relatively, time domain resource occupied by the first time-frequency resource set is configured to be “U”, and the interference to downlink reception will not exist, since the base station will not schedule downlink transmissions in the time-domain resources.

The present application provides a method in a second node for wireless communications, comprising:
transmitting a first signaling, the first signaling being used to indicate a first reference signal resource; and
transmitting a first signal in a first time-frequency resource set, the first reference signal resource being used to determine spatial parameters of the first signal;
herein, the first signaling is used to indicate the first time-frequency resource set; the first reference signal resource is one of K1 candidate reference signal resources, K1 is a positive integer greater than 1, and the first signaling indicates the first reference signal resource from the K1 candidate reference signal resources; a target reference signal resource set comprises K1 candidate reference signal resources, and the target reference signal resource set is one of M1 reference signal resource sets, where M1 is a positive integer greater than 1; time-domain resources occupied by the first time-frequency resource set are used to determine the target reference signal resource set from the M1 reference signal resource sets.

The present application provides a method in a second node for wireless communications, comprising:
transmitting a first signaling, the first signaling being used to indicate a first reference signal resource; and
receiving a first signal in a first time-frequency resource set, the first reference signal resource being used to determine spatial parameters of the first signal;
herein, the first signaling is used to indicate the first time-frequency resource set; the first reference signal resource is one of K1 candidate reference signal resources, K1 is a positive integer greater than 1, and the first signaling indicates the first reference signal resource from the K1 candidate reference signal resources; a target reference signal resource set comprises K1 candidate reference signal resources, and the target reference signal resource set is one of M1 reference signal resource sets, where M1 is a positive integer greater than 1; time-domain resources occupied by the first time-frequency resource set are used to determine the target reference signal resource set from the M1 reference signal resource sets.

According to one aspect of the present application, the M1 reference signal resource sets comprise a first reference signal resource set and a second reference signal resource set, and time-domain resources occupied by the first time-frequency resource set comprise a first symbol set; when a format adopted by a symbol in the first symbol set is a first format, the target reference signal resource set is the first reference signal resource set; when a format adopted by a symbol in the first symbol set is a second format, the target reference signal resource set is the second reference signal resource set; the first format and the second format are different.

According to one aspect of the present application, the M1 reference signal resource sets comprise a first reference signal resource set and a second reference signal resource set, and time-domain resources occupied by the first time-frequency resource set belong to a first time unit; when the first time unit is a time unit in a first time unit set, the target reference signal resource set is the first reference signal resource set; when the first time unit is a time unit in a second time unit set, the target reference signal resource set is the second reference signal resource set; a format of any time unit in the first time unit set is different from a format of any time unit in the second time unit set.

According to one aspect of the present application, comprising:
transmitting a first information block;
herein, the first information block is used to indicate a format adopted by a symbol comprised in the time-domain resources occupied by the first time-frequency resource set.

According to one aspect of the present application, comprising:
receiving a second information block;
herein, the second information block is used to indicate the M1 reference signal resource sets.

According to one aspect of the present application, transmit power of the first signal is equal to a first power value, the first power value is not greater than a first threshold, the first threshold is one of M2 candidate thresholds, time-domain resources occupied by the first time-frequency resource set are used to determine the first threshold from the M2 candidate thresholds; M2 is a positive integer greater than 1.

According to one aspect of the present application, transmit power of the first signal is equal to a first power value, the first power value is linearly correlated with a target power value, the target power value is equal to one of M3 candidate power values, and time-domain resources occupied by the first time-frequency resource set are used to determine the target power value from the M3 candidate power values, M3 is a positive integer greater than 1.

The present application provides a first node for wireless communications, comprising:
a first receiver, receiving a first signaling, the first signaling being used to indicate a first reference signal resource; and
a first transceiver, receiving a first signal in a first time-frequency resource set, the first reference signal resource being used to determine spatial parameters of the first signal;
herein, the first signaling is used to indicate the first time-frequency resource set; the first reference signal resource is one of K1 candidate reference signal resources, K1 is a positive integer greater than 1, and the first signaling indicates the first reference signal resource from the K1 candidate reference signal resources; a target reference signal resource set comprises K1 candidate reference signal resources, and the target reference signal resource set is one of M1 reference signal resource sets, where M1 is a positive integer greater than 1; time-domain resources occupied by the first time-frequency resource set are used to determine the target reference signal resource set from the M1 reference signal resource sets.

The present application provides a first node for wireless communications, comprising:
a first receiver, receiving a first signaling, the first signaling being used to indicate a first reference signal resource; and
a first transceiver, transmitting a first signal in a first time-frequency resource set, the first reference signal resource being used to determine spatial parameters of the first signal;
herein, the first signaling is used to indicate the first time-frequency resource set; the first reference signal resource is one of K1 candidate reference signal resources, K1 is a positive integer greater than 1, and the first signaling indicates the first reference signal resource from the K1 candidate reference signal resources; a target reference signal resource set comprises K1 candidate reference signal resources, and the target reference signal resource set is one of M1 reference signal resource sets, where M1 is a positive integer greater than 1; time-domain resources occupied by the first time-frequency resource set are used to determine the target reference signal resource set from the M1 reference signal resource sets.

The present application provides a second node for wireless communications, comprising:
a first transmitter, transmitting a first signaling, the first signaling being used to indicate a first reference signal resource; and
a second transceiver, transmitting a first signal in a first time-frequency resource set, the first reference signal resource being used to determine spatial parameters of the first signal;
herein, the first signaling is used to indicate the first time-frequency resource set; the first reference signal resource is one of K1 candidate reference signal resources, K1 is a positive integer greater than 1, and the first signaling indicates the first reference signal resource from the K1 candidate reference signal resources; a target reference signal resource set comprises K1 candidate reference signal resources, and the target reference signal resource set is one of M1 reference signal resource sets, where M1 is a positive integer greater than 1; time-domain resources occupied by the first time-frequency resource set are used to determine the target reference signal resource set from the M1 reference signal resource sets.

The present application provides a second node for wireless communications, comprising:
a first transmitter, transmitting a first signaling, the first signaling being used to indicate a first reference signal resource; and
a second transceiver, receiving a first signal in a first time-frequency resource set, the first reference signal resource being used to determine spatial parameters of the first signal;
herein, the first signaling is used to indicate the first time-frequency resource set; the first reference signal resource is one of K1 candidate reference signal resources, K1 is a positive integer greater than 1, and the first signaling indicates the first reference signal resource from the K1 candidate reference signal resources; a target reference signal resource set comprises K1 candidate reference signal resources, and the target reference signal resource set is one of M1 reference signal resource sets, where M1 is a positive integer greater than 1; time-domain resources occupied by the first time-frequency resource set are used to determine the target reference signal resource set from the M1 reference signal resource sets.

In one embodiment, the present application has the following advantages over conventional schemes:
a connection is established between a TCI or SRI indicated by the first signaling and time-domain resources occupied by the first time-frequency resource set; when the interference situation corresponding to time-domain resources occupied by the first time-frequency resource set changes, one reference signal resource set from the corresponding M1 reference signal resource sets can be used as the target reference signal resource set, thereby reducing interference and ensuring system performance;
when the first node receives the first signal and time-domain resources occupied by the first time-frequency resource set are configured as “F”, a TCI adopted by the first signal should avoid interference from the uplink beam; relatively, time-domain resources occupied by the first time-frequency resource set are configured as “D”, and the above mentioned beam interference from the uplink does not exist, and can be configured in the same way as the existing TCI list for the downlink data channel;
when the first node transmits the first signal and time-domain resources occupied by the first time-frequency resource set are configured as “F”, the SRI adopted by first signal shall avoid interference with the downlink beam; relatively, time-domain resources occupied by the first time-frequency resource set are configured as “U”, and the above mentioned interference to the downlink beam does not exist, and can be configured in the same way as the existing SRI lists for the uplink data channel;
a connection between time-domain resources occupied by the first time-frequency resource set and a transmit power value of the first signal is established, and then whether the occupied time-domain resources are configured as “F” is used to determine a transmit power value of the first signal, so as to avoid interference with the corresponding directional transmission to improve performance.

The present application provides a method in a first node for wireless communications, comprising:
receiving a first information block and a first signaling, the first information block comprising configuration information of a target sub-band, configuration information of the target sub-band being used to at least determine a slot format for the target sub-band, and the first signaling being used to determine a first time-frequency resource set and a first reference signal resource; and
receiving a first signal in the first time-frequency resource set, the first reference signal resource being used to determine spatial parameters of the first signal;
herein, the first time-frequency resource set comprises at least one resource block in frequency domain and at least one symbol in time domain; the first reference signal resource is one of K1 candidate reference signal resources, K1 is a positive integer greater than 1, and the first signaling indicates the first reference signal resource from the K1 candidate reference signal resources; a target reference signal resource set comprises K1 candidate reference signal resources, and the target reference signal resource set is one of M1 reference signal resource sets, where M1 is a positive integer greater than 1; at least one of a relation between the first time-frequency resource set and the target sub-band, or configuration information of the target sub-band is used to determine the target reference signal resource set from the M1 reference signal resource sets; frequency-domain resources occupied by the first time-frequency resource set and the target sub-band belong to a same BWP (bandwidth part, carrier part).

The present application provides a method in a first node for wireless communications, comprising:
receiving a first information block and a first signaling, the first information block comprising configuration information of a target sub-band, configuration information of the target sub-band being used to at least determine a slot format for the target sub-band, and the first signaling being used to determine a first time-frequency resource set and a first reference signal resource; and
transmitting a first signal in the first time-frequency resource set, the first reference signal resource being used to determine spatial parameters of the first signal;
herein, the first time-frequency resource set comprises at least one resource block in frequency domain and at least one symbol in time domain; the first reference signal resource is one of K1 candidate reference signal resources, K1 is a positive integer greater than 1, and the first signaling indicates the first reference signal resource from the K1 candidate reference signal resources; a target reference signal resource set comprises K1 candidate reference signal resources, and the target reference signal resource set is one of M1 reference signal resource sets, where M1 is a positive integer greater than 1; at least one of a relation between the first time-frequency resource set and the target sub-band, or configuration information of the target sub-band is used to determine the target reference signal resource set from the M1 reference signal resource sets; frequency-domain resources occupied by the first time-frequency resource set and the target sub-band belong to a same BWP.

In one embodiment, one technical feature of the above method is in: establishing a connection between a TCI or SRI (Sounding Reference Signal Resource Indicator) indicated by the first signaling and the target sub-band; one way of the above connection is a frequency-domain position relation between the first time-frequency resource set and the target sub-band, and another way of the above connection is configuration information of the target sub-band; furthermore, when a link direction on the target sub-band is flexible or variable, the transmission on the target sub-band will interfere with the transmission in the first time-frequency resource set, and the interference can be avoided by selecting different reference signal resource sets from the M1 reference signal resource sets.

In one embodiment, another technical feature of the above method is in: when the first time-frequency resource set belongs to the target sub-band, or the first time-frequency resource set overlaps with the target sub-band, and the target sub-band is configured to support flexible or variable link directions, the target reference signal resource set is a given reference signal resource set among the M1 reference signal resource sets to avoid interference between cross links during beamforming transmission; when the first time-frequency resource set does not belong to the target sub-band, or the first time-frequency resource set does not overlap with the target sub-band, or a link direction configured by the target sub-band is the same as a link direction configured by a sub-band where the first time-frequency resource set is located, the target reference signal resource set is a reference signal resource set other than the given reference signal resource set among the M1 reference signal resource sets, that is, a reference signal resource set that does not need to consider cross link interference is adopted to indicate actually-adopted reference signal resources.

According to one aspect of the present application, a first boundary frequency is equal to a lowest boundary frequency of the target sub-band, and a second boundary frequency is equal to a highest boundary frequency of the target sub-band; a first reference frequency is equal to a difference value in an interval length between the first boundary frequency and a target frequency, and a second reference frequency is equal to a sum of an interval length between a second boundary frequency and the target frequency; a first frequency interval is a frequency interval between the first boundary frequency and the first reference frequency, and a second frequency interval is a frequency interval from the second reference frequency to the second boundary frequency; a location relation between the first time-frequency resource set in frequency domain and the first frequency interval, or a location relation between the second frequency intervals, is used to determine the target reference signal resource set from the M1 reference signal resource sets.

In one embodiment, one technical feature of the above method is in: the first frequency interval and the second frequency interval are protection frequency bands on both sides of the target sub-band, and there exists overlapped scheduling with the protection frequency band, and it is necessary to use a given reference signal resource set from the M1 reference signal resource sets to avoid cross link interference; if there exists no overlapped scheduling with the protected frequency band, the traditional reference signal resource set is used to determine a beamforming vector adopted by transmission.

According to one aspect of the present application, configuration information of the target sub-band comprises at least one of location information of the target sub-band in frequency domain or a link direction indication of the target sub-band; when configuration information of the target sub-band comprises a link direction indication of the target sub-band, a link direction indication of the target sub-band is used to determine a slot format for the target sub-band.

In one embodiment, one technical feature of the above method is in: when the target sub-band supports flexible or variable link direction, it is necessary to use a given reference signal resource set from the M1 reference signal resource sets to avoid cross link interference; when the target sub-band adopts a fixed link direction, the traditional reference signal resource set is used to determine a beamforming vector adopted for transmission.

According to one aspect of the present application: the M1 reference signal resource sets comprise a first reference signal resource set and a second reference signal resource set; the first node receives a first signal in the first time-frequency resource set; when there exists an overlapping between the first time-frequency resource set and the first frequency interval or the second frequency interval in frequency domain, and a link direction of the target sub-band is flexible or variable, the target reference signal resource set is the first reference signal resource set; when there does not exist an overlapping between the first time-frequency resource set and any of the first frequency interval or the second frequency interval in frequency domain, the target reference signal resource set is the second reference signal resource set.

According to one aspect of the present application: the M1 reference signal resource sets comprise a third reference signal resource set and a fourth reference signal resource set; the first node transmits a first signal in the first time-frequency resource set; when there exists an overlapping between the first time-frequency resource set and the first frequency interval or the second frequency interval in frequency domain, and a link direction of the target sub-band is flexible or variable, the target reference signal resource set is the third reference signal resource set; when there does not exist an overlapping between the first time-frequency resource set and any of the first frequency interval or the second frequency interval in frequency domain, the target reference signal resource set is the fourth reference signal resource set.

According to one aspect of the present application, comprising:
receiving a second information block;
herein, the second information block is used to indicate the M1 reference signal resource sets.

According to one aspect of the present application, transmit power of the first signal is equal to a first power value, the first power value is not greater than a first threshold, the first threshold is one of M2 candidate thresholds, and at least one of a relation between the first time-frequency resource set and the target sub-band or configuration information of the target sub-band is used to determine the first threshold from the M2 candidate thresholds; M2 is a positive integer greater than 1.

In one embodiment, one technical feature of the above method is in: furthermore, a relation between transmit power of the first signal and the target sub-band or configuration information of the target sub-band is established; further cross link interference is avoided to improve the system performance.

The present application provides a method in a second node for wireless communications, comprising:
transmitting a first information block and a first signaling, the first information block comprising configuration information of a target sub-band, configuration information of the target sub-band being used to at least determine a slot format for the target sub-band, and the first signaling being used to determine a first time-frequency resource set and a first reference signal resource; and
transmitting a first signal in the first time-frequency resource set, the first reference signal resource being used to determine spatial parameters of the first signal;
herein, the first time-frequency resource set comprises at least one resource block in frequency domain and at least one symbol in time domain; the first reference signal resource is one of K1 candidate reference signal resources, K1 is a positive integer greater than 1, and the first signaling indicates the first reference signal resource from the K1 candidate reference signal resources; a target reference signal resource set comprises K1 candidate reference signal resources, and the target reference signal resource set is one of M1 reference signal resource sets, where M1 is a positive integer greater than 1; at least one of a relation between the first time-frequency resource set and the target sub-band, or configuration information of the target sub-band is used to determine the target reference signal resource set from the M1 reference signal resource sets; frequency-domain resources occupied by the first time-frequency resource set and the target sub-band belong to a same BWP.

The present application provides a method in a second node for wireless communications, comprising:
transmitting a first information block and a first signaling, the first information block comprising configuration information of a target sub-band, configuration information of the target sub-band being used to at least determine a slot format for the target sub-band, and the first signaling being used to determine a first time-frequency resource set and a first reference signal resource; and
receiving a first signal in the first time-frequency resource set, the first reference signal resource being used to determine spatial parameters of the first signal;
herein, the first time-frequency resource set comprises at least one resource block in frequency domain and at least one symbol in time domain; the first reference signal resource is one of K1 candidate reference signal resources, K1 is a positive integer greater than 1, and the first signaling indicates the first reference signal resource from the K1 candidate reference signal resources; a target reference signal resource set comprises K1 candidate reference signal resources, and the target reference signal resource set is one of M1 reference signal resource sets, where M1 is a positive integer greater than 1; at least one of a relation between the first time-frequency resource set and the target sub-band, or configuration information of the target sub-band is used to determine the target reference signal resource set from the M1 reference signal resource sets; frequency-domain resources occupied by the first time-frequency resource set and the target sub-band belong to a same BWP.

According to one aspect of the present application, a first boundary frequency is equal to a lowest boundary frequency of the target sub-band, and a second boundary frequency is equal to a highest boundary frequency of the target sub-band; a first reference frequency is equal to a difference value in an interval length between the first boundary frequency and a target frequency, and a second reference frequency is equal to a sum of an interval length between a second boundary frequency and the target frequency; a first frequency interval is a frequency interval between the first boundary frequency and the first reference frequency, and a second frequency interval is a frequency interval from the second reference frequency to the second boundary frequency; a location relation between the first time-frequency resource set in frequency domain and the first frequency interval, or a location relation between the second frequency intervals, is used to determine the target reference signal resource set from the M1 reference signal resource sets.

According to one aspect of the present application, configuration information of the target sub-band comprises at least one of location information of the target sub-band in frequency domain or a link direction indication of the target sub-band; when configuration information of the target sub-band comprises a link direction indication of the target sub-band, a link direction indication of the target sub-band is used to determine a slot format for the target sub-band.

According to one aspect of the present application, the M1 reference signal resource sets comprise a first reference signal resource set and a second reference signal resource set; the second node transmits a first signal in the first time-frequency resource set; when there exists an overlapping between the first time-frequency resource set and the first frequency interval or the second frequency interval in frequency domain, and a link direction of the target sub-band is flexible or variable, the target reference signal resource set is the first reference signal resource set; when there does not exist an overlapping between the first time-frequency resource set and any of the first frequency interval or the second frequency interval in frequency domain, the target reference signal resource set is the second reference signal resource set.

According to one aspect of the present application, the M1 reference signal resource sets comprise a third reference signal resource set and a fourth reference signal resource set; the second node receives a first signal in the first time-frequency resource set; when there exists an overlapping between the first time-frequency resource set and the first frequency interval or the second frequency interval in frequency domain, and a link direction of the target sub-band is flexible or variable, the target reference signal resource set is the third reference signal resource set; when there does not exist an overlapping between the first time-frequency resource set and any of the first frequency interval or the second frequency interval in frequency domain, the target reference signal resource set is the fourth reference signal resource set.

According to one aspect of the present application, comprising:
receiving a second information block;
herein, the second information block is used to indicate the M1 reference signal resource sets.

According to one aspect of the present application, transmit power of the first signal is equal to a first power value, the first power value is not greater than a first threshold, the first threshold is one of M2 candidate thresholds, and at least one of a relation between the first time-frequency resource set and the target sub-band or configuration information of the target sub-band is used to determine the first threshold from the M2 candidate thresholds; M2 is a positive integer greater than 1.

The present application provides a first node for wireless communications, comprising:
a first receiver, receiving a first information block and a first signaling, the first information block comprising configuration information of a target sub-band, configuration information of the target sub-band being used to at least determine a slot format for the target sub-band, and the first signaling being used to determine a first time-frequency resource set and a first reference signal resource; and
a first transceiver, receiving a first signal in the first time-frequency resource set, the first reference signal resource being used to determine spatial parameters of the first signal;
herein, the first time-frequency resource set comprises at least one resource block in frequency domain and at least one symbol in time domain; the first reference signal resource is one of K1 candidate reference signal resources, K1 is a positive integer greater than 1, and the first signaling indicates the first reference signal resource from the K1 candidate reference signal resources; a target reference signal resource set comprises K1 candidate reference signal resources, and the target reference signal resource set is one of M1 reference signal resource sets, where M1 is a positive integer greater than 1; at least one of a relation between the first time-frequency resource set and the target sub-band, or configuration information of the target sub-band is used to determine the target reference signal resource set from the M1 reference signal resource sets; frequency-domain resources occupied by the first time-frequency resource set and the target sub-band belong to a same BWP.

The present application provides a first node for wireless communications, comprising:
a first receiver, receiving a first information block and a first signaling, the first information block comprising configuration information of a target sub-band, configuration information of the target sub-band being used to at least determine a slot format for the target sub-band, and the first signaling being used to determine a first time-frequency resource set and a first reference signal resource; and
a first transceiver, transmitting a first signal in the first time-frequency resource set, the first reference signal resource being used to determine spatial parameters of the first signal;
herein, the first time-frequency resource set comprises at least one resource block in frequency domain and at least one symbol in time domain; the first reference signal resource is one of K1 candidate reference signal resources, K1 is a positive integer greater than 1, and the first signaling indicates the first reference signal resource from the K1 candidate reference signal resources; a target reference signal resource set comprises K1 candidate reference signal resources, and the target reference signal resource set is one of M1 reference signal resource sets, where M1 is a positive integer greater than 1; at least one of a relation between the first time-frequency resource set and the target sub-band, or configuration information of the target sub-band is used to determine the target reference signal resource set from the M1 reference signal resource sets; frequency-domain resources occupied by the first time-frequency resource set and the target sub-band belong to a same BWP.

The present application provides a second node for wireless communications, comprising:
a first transmitter, transmitting a first information block and a first signaling, the first information block comprising configuration information of a target sub-band, configuration information of the target sub-band being used to at least determine a slot format for the target sub-band, and the first signaling being used to determine a first time-frequency resource set and a first reference signal resource; and
a second transceiver, transmitting a first signal in the first time-frequency resource set, the first reference signal resource being used to determine spatial parameters of the first signal;
herein, the first time-frequency resource set comprises at least one resource block in frequency domain and at least one symbol in time domain; the first reference signal resource is one of K1 candidate reference signal resources, K1 is a positive integer greater than 1, and the first signaling indicates the first reference signal resource from the K1 candidate reference signal resources; a target reference signal resource set comprises K1 candidate reference signal resources, and the target reference signal resource set is one of M1 reference signal resource sets, where M1 is a positive integer greater than 1; at least one of a relation between the first time-frequency resource set and the target sub-band, or configuration information of the target sub-band is used to determine the target reference signal resource set from the M1 reference signal resource sets; frequency-domain resources occupied by the first time-frequency resource set and the target sub-band belong to a same BWP.

The present application provides a second node for wireless communications, comprising:
a first transmitter, transmitting a first information block and a first signaling, the first information block comprising configuration information of a target sub-band, configuration information of the target sub-band being used to at least determine a slot format for the target sub-band, and the first signaling being used to determine a first time-frequency resource set and a first reference signal resource; and
a second transceiver, receiving a first signal in the first time-frequency resource set, the first reference signal resource being used to determine spatial parameters of the first signal;
herein, the first time-frequency resource set comprises at least one resource block in frequency domain and at least one symbol in time domain; the first reference signal resource is one of K1 candidate reference signal resources, K1 is a positive integer greater than 1, and the first signaling indicates the first reference signal resource from the K1 candidate reference signal resources; a target reference signal resource set comprises K1 candidate reference signal resources, and the target reference signal resource set is one of M1 reference signal resource sets, where M1 is a positive integer greater than 1; at least one of a relation between the first time-frequency resource set and the target sub-band, or configuration information of the target sub-band is used to determine the target reference signal resource set from the M1 reference signal resource sets; frequency-domain resources occupied by the first time-frequency resource set and the target sub-band belong to a same BWP.

In one embodiment, the present application has the following advantages over conventional schemes:
a connection between the TCI or SRI indicated by the first signaling signal and the target sub-band is established; one way of the above connection is a frequency-domain position relation between the first time-frequency resource set and the target sub-band, and another way of the above connection is configuration information of the target sub-band; furthermore, when a link direction on the target sub-band is flexible or variable, the transmission on the target sub-band will interfere with the transmission in the first time-frequency resource set, and the interference can be avoided by selecting different reference signal resource sets from the M1 reference signal resource sets;
when the first time-frequency resource set belongs to the target sub-band, or the first time-frequency resource set overlaps with the target sub-band, and the target sub-band is configured to support flexible or variable link direction, the target reference signal resource set is a given reference signal resource set among the M1 reference signal resource sets to avoid interference between cross links during beamforming transmission; when the first time-frequency resource set does not belong to the target sub-band, or the first time-frequency resource set does not overlap with the target sub-band, or a link direction configured in the target sub-band is the same as a link direction configured in a sub-band where the first time-frequency resource set is located, the target reference signal resource set is a reference signal resource set other than the given reference signal resource set among the M1 reference signal resource sets, that is, a reference signal resource set that does not need to consider cross link interference is used to indicate actually-adopted reference signal resources;
furthermore, a relation between transmit power of the first signal and the target sub-band or configuration information of the target sub-band is established, so as to avoid cross link interference to improve system performance.

### BRIEF DESCRIPTION OF THE DRAWINGS

Other features, objects and advantages of the present application will become more apparent from the detailed description of non-restrictive embodiments taken in conjunction with the following drawings:

FIG. 1A illustrates a flowchart of the processing of a first node according to one embodiment of the present application;

FIG. 1B illustrates a flowchart of the processing of a first node according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5A illustrates a flowchart of a first signaling according to one embodiment of the present application;

FIG. 5B illustrates a flowchart of a first signaling according to one embodiment of the present application;

FIG. 6A illustrates a flowchart of a first signaling according to another embodiment of the present application;

FIG. 6B illustrates a flowchart of a first signaling according to another embodiment of the present application;

FIG. 7A illustrates a schematic diagram of M1 reference signal resource sets according to one embodiment of the present application;

FIG. 7B illustrates a schematic diagram of M1 reference signal resource sets according to one embodiment of the present application;

FIG. 8A illustrates a schematic diagram of time-domain resources occupied by the first time-frequency resource set according to one embodiment of the present application;

FIG. 8B illustrates a schematic diagram of a first frequency interval and a second frequency interval according to one embodiment of the present application;

FIG. 9A illustrates a schematic diagram of an application scenario according to one embodiment of the present application;

FIG. 9B illustrates a schematic diagram of configuration information of a target sub-band according to one embodiment of the present application;

FIG. 10A illustrates a schematic diagram of an application scenario according to another embodiment of the present application;

FIG. 10B illustrates a schematic diagram of a target sub-band according to one embodiment of the present application;

FIG. 11A illustrates a structure block diagram of a processor in a first node according to one embodiment of the present application;

FIG. 11B illustrates a schematic diagram of a slot format of a target sub-band according to one embodiment of the present application;

FIG. 12A illustrates a structure block diagram of a processor in a second node according to one embodiment of the present application;

FIG. 12B illustrates a schematic diagram of a first power value according to one embodiment of the present application;

FIG. 13 illustrates a structure block diagram of a processor in a first node according to one embodiment of the present application;

FIG. 14 illustrates a structure block diagram of a processor in second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1A

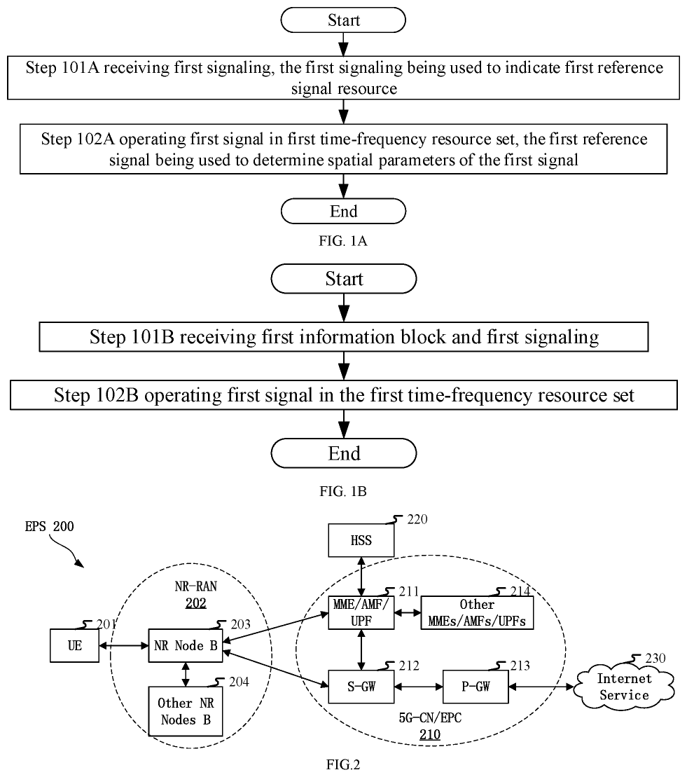

Embodiment 1A illustrates a processing flowchart of a first node, as shown in FIG. 1A. In step 100A illustrated by FIG. 1A, each box represents a step. In embodiment 1A, a first node in the present application receives a first signaling in step 101A, and the first signaling is used to indicate a first reference signal resource; in step 102A, operates a first signal in a first time-frequency resource set, and the first reference signal resource is used to determine spatial parameters of the first signal.

In embodiment 1A, the first signaling is used to indicate the first time-frequency resource set; the first reference signal resource is one of K1 candidate reference signal resources, K1 is a positive integer greater than 1, and the first signaling indicates the first reference signal resource from the K1 candidate reference signal resources; a target reference signal resource set comprises K1 candidate reference signal resources, and the target reference signal resource set is one of M1 reference signal resource sets, where M1 is a positive integer greater than 1; time-domain resources occupied by the first time-frequency resource set are used to determine the target reference signal resource set from the M1 reference signal resource sets; the operating action is receiving, or the operating action is transmitting.

In one embodiment, the first signaling is a piece of Downlink Control Information (DCI).

In one embodiment, the operating action is receiving, and the first signaling is a downlink grant.

In one embodiment, the operating action is transmitting, and the first signaling is an uplink grant.

In one embodiment, a physical-layer channel occupied by the first signaling comprises a Physical Downlink Control Channel (PDCCH).

In one embodiment, the first signaling is a Medium Access Control (MAC) Control Element (CE).

In one embodiment, a physical-layer channel occupied by the first signaling comprises a Physical Downlink Shared Channel (PDSCH).

In one embodiment, the first signaling is an RRC (Radio Resource Control) signaling.

In one embodiment, the first reference signal resource comprises Channel-State Information Reference Signal (CSI-RS) resources.

In one embodiment, the first reference signal resource comprises Demodulation Reference Signal (DMRS) resources.

In one embodiment, the first reference signal resource comprises Sounding Reference Signal (SRS) resources.

In one embodiment, the first reference signal resource comprises an SS/PBCH Block (SSB).

In one embodiment, the first reference signal resource corresponds to a TCI.

In one embodiment, the first reference signal resource corresponds to a TCI-State.

In one embodiment, the first reference signal resource corresponds to a TCI-StateId.

In one embodiment, the first reference signal resource corresponds to an SRI.

In one embodiment, the first time-frequency resource set occupies more than one positive integer number of Resource Element (RE).

In one embodiment, the first signal is a baseband signal.

In one embodiment, the first signal is a radio signal.

In one embodiment, the operating action is receiving, and a physical-layer channel occupied by the first signal comprises a PDSCH.

In one embodiment, the operating action is receiving, and a transmission channel occupied by the first signal comprises a DL-SCH (Downlink Shared Channel).

In one embodiment, the operating action is transmitting, and a physical-layer channel occupied by the first signal comprises a PUSCH (Physical Uplink Shared Channel).

In one embodiment, the operating action is transmitting, and a transmission channel occupied by the first signal comprises an Uplink Shared Channel (UL-SCH).

In one embodiment, the operating action is receiving, and spatial parameters of the first signal are spatial parameters of a demodulation reference signal of a channel occupied by the first signal.

In one embodiment, the operating action is receiving, and the spatial parameters are QCL (Quasi Co located) parameters.

In one embodiment, the operating action is receiving, and the spatial parameters are spatial reception parameters.

In one embodiment, the operating action is receiving, and the spatial parameters are spatial reception filtering.

In one embodiment, the operating action is receiving, and the meaning that the first reference signal resource is used to determine spatial parameters of the first signal comprises: a demodulation reference signal of a channel occupied by the first signal and the first reference signal resource are quasi co-located.

In one embodiment, the operating action is transmitting, and the spatial parameters are spatial transmission parameters.

In one embodiment, the operating action is transmitting, and the spatial parameters are spatial domain transmission filters.

In one embodiment, the operating action is transmitting, and the spatial parameters are spatial relations.

In one embodiment, the operating action is transmitting, and the spatial parameters comprise pre-coder.

In one embodiment, the operating action is transmitting, and the meaning of the phrase that the first reference signal resource is used to determine spatial parameters of the first signal comprises: transmission precoding of the first signal is determined by the first reference signal resource.

In one embodiment, a type of QCL in the present application comprises QCL Type A.

In one embodiment, a type of QCL in the present application comprises QCL Type B.

In one embodiment, a type of QCL in the present application comprises QCL Type C.

In one embodiment, a type of QCL in the present application comprises QCL Type D.

In one embodiment, the first signaling is used to indicate time-domain resources occupied by the first time-frequency resource set.

In one embodiment, the first signaling is used to indicate a number of symbols occupied by the first time-frequency resource set.

In one embodiment, the first signaling is used to indicate a time-domain location of a first one of symbols occupied by the first time-frequency resource set.

In one embodiment, the first signaling is used to indicate a time-domain location of an earliest one of symbols in time domain occupied by the first time-frequency resource set.

In one embodiment, the first signaling is used to indicate frequency-domain resources occupied by the first time-frequency resource set.

In one embodiment, the first signaling is used to indicate a frequency-domain location of RB(s) (Resource Block(s)) occupied by the first time-frequency resource set.

In one embodiment, any one of the K1 candidate reference signal resources comprises at least one of CSI-RS resources or an SSB.

In one embodiment, any one of the K1 candidate reference signal resources comprises DMRS resources.

In one embodiment, any one of the K1 candidate reference signal resources comprises SRS resources.

In one embodiment, any one of the K1 candidate reference signal resources corresponds to a TCI.

In one embodiment, any one of the K1 candidate reference signal resources corresponds to a TCI-State.

In one embodiment, any one of the K1 candidate reference signal resources corresponds to a TCI-StateId.

In one embodiment, any one of the K1 candidate reference signal resources corresponds to an SRI.

In one embodiment, the first signaling comprises a first field, and the first field comprised in the first signaling indicates the first reference signal resource from the K1 candidate reference signal resources.

In one subembodiment of the embodiment, the operating action is receiving, the first signaling is a PDCCH, and the first field comprised in the first signaling is a TCI field.

In one subembodiment of the embodiment, the operating action is transmitting, the first signaling is a PDCCH, and the first field comprised in the first signaling is an SRI field.

In one embodiment, the operating action is receiving, and the first signaling is a TCI States Activation/Activation for UE specific PDSCH MAC CE.

In one embodiment, the operating action is transmitting, and the first signaling is a Serving Cell Set Based Spatial Relation Indication MAC CE.

In one embodiment, the target reference signal resource set corresponds to a TCI list, the TCI list comprises K1 TCIs, and the K1 TCIs respectively correspond to K1 candidate reference signal resources.

In one embodiment, the target reference signal resource set corresponds to an SRI list, the SRI list comprises K1 TCIs, and the K1 SRIs respectively correspond to K1 candidate reference signal resources.

In one embodiment, the M1 reference signal resource sets respectively correspond to M1 TCI lists.

In one embodiment, the M1 reference signal resource sets respectively correspond to M1 SRI lists.

In one embodiment, any one of the M1 reference signal resource sets comprises at least one reference signal resource, and the reference signal resource comprises at least one of CSI-RS resources, SSB, DMRS resources, or SRS resources.

In one embodiment, any one of the M1 reference signal resource sets comprises at least one reference signal resource, and the reference signal resource corresponds to a TCI.

In one embodiment, any one of the M1 reference signal resource sets comprises at least one reference signal resource, and the reference signal resource corresponds to a TCI-State.

In one embodiment, any one of the M1 reference signal resource sets comprises at least one reference signal resource, and the reference signal resource corresponds to a TCI-StateId.

In one embodiment, any one of the M1 reference signal resource sets comprises at least one reference signal resource, and the reference signal resource corresponds to an SRI.

In one embodiment, the meaning of the phrase of time-domain resources occupied by the first time-frequency resource set comprises: a time-domain location of symbols occupied by the first time-frequency resource set in time domain.

In one embodiment, the meaning of the phrase of time-domain resources occupied by the first time-frequency resource set comprises: a time-domain location of a slot occupied by the first time-frequency resource set in time domain.

In one embodiment, the meaning of the phrase of time-domain resources occupied by the first time-frequency resource set comprises: a format of symbols occupied by the first time-frequency resource set in time domain.

In one embodiment, the meaning of the phrase of time-domain resources occupied by the first time-frequency resource set comprises: a format of a slot occupied by the first time-frequency resource set in time domain.

In one embodiment, the meaning of the phrase of time-domain resources occupied by the first time-frequency resource set comprises: a type of symbols occupied by the first time-frequency resource set in time domain is one of Downlink, Uplink, or Flexible.

In one embodiment, the meaning of the phrase of time-domain resources occupied by the first time-frequency resource set comprises: a type of a slot occupied by the first time-frequency resource set in time domain, and the type of the slot is one of downlink, uplink, or flexible.

In one embodiment, the symbol in the present application is an Orthogonal Frequency Division Multiplexing (OFDM) symbol.

In one embodiment, the symbol in the present application is a Single Carrier-Frequency Division Multiple Access (SC-FDMA) symbol.

In one embodiment, the symbol in the present application is a Filter Bank Multi Carrier (FBMC) symbol.

In one embodiment, the symbol in the present application is an OFDM symbol that comprises a Cyclic Prefix (CP).

In one embodiment, the symbol in the present application is a Discrete Fourier Transform Spreading Orthogonal Frequency Division Multiplexing (DFT-s-OFDM) symbol that comprises a CP.

In one embodiment, a slot in the present application is a slot.

In one embodiment, a slot in the present application occupies continuous W1 symbols in time domain, where W1 is a positive integer greater than 1.

In one subembodiment of the above embodiment, under normal cyclic prefix conditions, W1 is equal to 14.

In one subembodiment of the above embodiment, under extended cyclic prefix conditions, W1 is equal to 12.

In one embodiment, the first signal is generated by a Transport Block (TB).

In one embodiment, the first signal is generated by a Code Block (CB).

In one embodiment, the first signal is generated by a Code Block Group (CBG).

In one embodiment, the first signaling is used to schedule the first signal.

In one embodiment, the operating action is receiving, the first signal is used to activate a Semi Persistent Scheduling (SPS) configuration, and the first signal is a downlink assignment belonging to the SPS configured grant.

In one embodiment, the operating action is transmitting, the first signaling is used to activate a configured grant, and the first signal is an uplink grant belonging to the configured grant.

In one embodiment, a format adopted by the symbol in the present application refers to: a slot format adopted by the symbol.

In one embodiment, a format adopted by the symbol in the present application refers to: a transmission direction corresponding to the symbol.

In one embodiment, a format adopted by the symbol in the present application refers to: a transmission direction corresponding to the symbol is one of “downlink”, “uplink” or “flexible”.

In one embodiment, a format adopted by the slot in the present application refers to: a slot format adopted by the slot.

In one embodiment, a format adopted by the slot in the present application refers to: a transmission direction corresponding to the slot.

In one embodiment, a format adopted by the slot in the present application refers to: a transmission direction corresponding to the slot is one of “downlink”, “uplink” or “flexible”.

In one embodiment, a format of the time unit in the present application refers to: a slot format adopted by the time unit.

In one embodiment, a format of the time unit in the present application refers to: a transmission direction corresponding to the time unit.

In one embodiment, a format of the time unit in the present application refers to: a transmission direction corresponding to the time unit is one of “downlink”, “uplink” or “flexible”.

### Embodiment 1B

Embodiment 1B illustrates a processing flowchart of a first node, as shown in FIG. 1B. In step 100B illustrated by FIG. 1B, each box represents a step. In embodiment 1B, the first node in the present application receives a first information block and a first signaling in step 101B, the first information block comprises configuration information of a target sub-band, configuration information of the target sub-band is used to at least determine a slot format for the target sub-band, and the first signaling is used to determine a first time-frequency resource set and a first reference signal resource; in step 102B, operates a first signal on the first time-frequency resource set, and the first reference signal resource is used to determine spatial parameters of the first signal.

In embodiment 1B, the first time-frequency resource set comprises at least one resource block in frequency domain and at least one symbol in time domain; the first reference signal resource is one of K1 candidate reference signal resources, K1 is a positive integer greater than 1, and the first signaling indicates the first reference signal resource from the K1 candidate reference signal resources; a target reference signal resource set comprises K1 candidate reference signal resources, and the target reference signal resource set is one of M1 reference signal resource sets, where M1 is a positive integer greater than 1; at least one of a relation between the first time-frequency resource set and the target sub-band, or configuration information of the target sub-band is used to determine the target reference signal resource set from the M1 reference signal resource sets; frequency-domain resources occupied by the first time-frequency resource set and the target sub-band belong to a same BWP; the operating action is receiving, or, the operating action is transmitting.

In one embodiment, a frequency-domain bandwidth of the target sub-band is less than one BWP.

In one embodiment, frequency-domain resources occupied by the first time-frequency resource set and the target sub-band belong to a same BWP.

In one embodiment, the M1 reference signal resource sets are configured to a same BWP.

In one embodiment, the first information block comprises configurations of higher-layer information or higher-layer parameter.

In one embodiment, the first information block comprises one or more Information Elements (IEs) comprised in a Radio Resource Control (RRC) layer signaling, or the first information block comprises one or more fields comprised in an RRC signaling.

In one embodiment, the first information block comprises partial or all fields comprised in a Master Information Block (MIB).

In one embodiment, the first information block comprises partial or all fields comprised in a System Information Block (SIB).

In one embodiment, a physical-layer channel occupied by the first information block comprises a Physical Downlink Control Channel (PDCCH).

In one embodiment, the first information block is transmitted through a Medium Access Control (MAC) Control Element (CE).

In one embodiment, the first information block is transmitted through a physical-layer dynamic signaling.

In one embodiment, the first information block is UE specific or UE dedicated.

In one embodiment, the first information block is cell common or cell specific.

In one embodiment, the first information block comprises physical-layer control information or physical-layer control parameters.

In one embodiment, the first information block comprises partial or all fields in a Downlink Control Information (DCI) format.

In one embodiment, the first information block is transmitted through a Physical Downlink Control Channel (PDCCH).

In one embodiment, the first information block is the target sub-band specific or dedicated.

In one embodiment, the first information block is only used to configure the target sub-band.

In one embodiment, the first information block is dedicated to a sub-band other than the target sub-band that has a same ID or index as the target sub-band.

In one embodiment, the first information block is used to configure a sub-band other than the target sub-band that has a same ID or index as the target sub-band.

In one embodiment, a sub-band other than the target sub-band that has the same ID or index as the target sub-band shares all or partial configuration parameters in the first information block with the target sub-band.

In one embodiment, the first information block comprises partial or all fields in “BWP Flexible” of IEs (Information Elements).

In one embodiment, the first information block comprises partial or all fields in an IE “BWP Downlink”.

In one embodiment, the first information block comprises partial or all fields in an IE “BWP-Uplink”.

In one embodiment, the first information block comprises an IE other than an IE “BWP-Downlink” or IE “BWP-Uplink”.

In one embodiment, a name of an RRC signaling used to transmit the first information block comprises Slot.

In one embodiment, a name of an RRC signaling used to transmit the first information block comprises SlotFormat.

In one embodiment, a name of an RRC signaling used to transmit the first information block comprises Format.

In one embodiment, the first information block is transmitted through a MAC CE.

In one embodiment, a name of a MAC CE used for transmitting the first information block comprises Slot.

In one embodiment, a name of a MAC CE used for transmitting the first information block comprises SlotFormat.

In one embodiment, a name of a MAC CE used for transmitting the first information block comprises Format.

In one embodiment, the first information block is transmitted through DCI.

In one embodiment, when the first information block is transmitted through DCI, a format adopted by DCI is DCI Format 2_0

In one embodiment, the first information block is used to indicate that a slot format supported by the target sub-band is one of “D”, “U”, or “F”.

In one embodiment, the expression in the claim that the first information block comprises configuration information of a target sub-band comprises the following meaning: the first information block is used to determine configuration information of the target sub-band.

In one embodiment, the expression in the claim that the first information block comprises configuration information of a target sub-band comprises the following meaning: the first information block carries configuration information of the target sub-band.

In one embodiment, the expression in the claim that the first information block comprises configuration information of a target sub-band comprises the following meaning: one or more fields comprised in the first information block is used to explicitly or implicitly configure the target sub-band.

In one embodiment, the expression in the claim that the first information block comprises configuration information of a target sub-band comprises the following meaning: the first information block is used to explicitly or implicitly indicate values of one or more configuration parameters of the target sub-band.

In one embodiment, frequency-domain resources occupied by the target sub-band are less than one BWP (Bandwidth Part)

In one embodiment, frequency-domain resources occupied by the target sub-band are frequency-domain resources corresponding to positive integer number of RBs (Resource Blocks) greater than 1.

In one embodiment, an RB in the present application corresponds to a PRB (Physical Resource Block).

In one embodiment, an RB in the present application corresponds to a VRB (Virtual Resource Block).

In one embodiment, an RB in the present application occupies 12 continuous subcarriers.

In one embodiment, frequency-domain resources occupied by the target sub-band are one of the multiple sub-bands comprised in a BWP; any of the multiple sub-bands occupies frequency-domain resources corresponding to a positive integer number of PRBs greater than 1.

In one embodiment, the target sub-band is a sub-band that supports flexible or variable duplex.

In one embodiment, the target sub-band is a sub-band supports uplink and downlink at the same time.

In one embodiment, the target sub-band comprises at least one subcarrier.

In one embodiment, the target sub-band comprises at least one RB.

In one embodiment, all subcarriers comprised in the target sub-band belong to a same BWP.

In one embodiment, a BWP comprises the target sub-band.

In one embodiment, the target sub-band comprises multiple subcarriers, and a subcarrier spacing of any two subcarriers comprised in the target sub-band is equal.

In one embodiment, the target sub-band comprises multiple subcarriers, and subcarrier spacings of two subcarriers comprised in the target sub-band are not equal.

In one embodiment, the target sub-band comprises continuous frequency-domain resources.

In one embodiment, the target sub-band comprises discrete frequency-domain resources.

In one embodiment, the target sub-band comprises a guard subcarrier or a guard RB.

In one embodiment, the target sub-band comprises a subcarrier or a RB not available for transmission or allocation.

In one embodiment, configuration information of the target sub-band comprises a type of the target sub-band or a type of the sub-band set to which the target sub-band belongs.

In one embodiment, configuration information of the target sub-band comprises a type of a BWP set to which the target sub-band belongs.

In one embodiment, configuration information of the target sub-band comprises a duplex type of the target sub-band or a duplex type of a sub-band set to which the target sub-band belongs.

In one embodiment, configuration information of the target sub-band comprises whether the target sub-band belongs to a sub-band set supporting multiple link directions.

In one embodiment, configuration information of the target sub-band comprises whether the target sub-band belongs to a BWP supporting multiple link directions.

In one embodiment, configuration information of the target sub-band comprises whether the target sub-band is a sub-band with flexible or variable link direction, or whether the target sub-band belongs to a sub-band set with flexible or variable link direction (FL, Flexible Link or VL (Variable Link)).

In one embodiment, configuration information of the target sub-band comprises whether the target sub-band belongs to a BWP with flexible or variable link direction or whether the target sub-band belongs to a BWP set with flexible or variable link direction.

In one embodiment, configuration information of the target sub-band comprises whether the target sub-band supports a link direction of a time-domain symbol configured by an IE “tdd-UL-DL-ConfigCommon” as uplink or downlink being overridden.

In one embodiment, configuration information of the target sub-band comprises whether the target sub-band supports a link direction of a time-domain symbol configured by an IE “tdd-UL-DL-ConfigDedicated” as uplink or downlink being overridden.

In one embodiment, configuration information of the target sub-band comprises at least one of location information of the target sub-band in frequency domain or a link direction indication of the target sub-band.

In one embodiment, configuration information of the target sub-band comprises at least one of location information of the target sub-band in frequency domain, a link direction indication of the target sub-band, a subcarrier spacing indication, a starting CRB (Common Resource Block) indication, a number of CRBs comprised, or an index list of BWPs comprised.

In one embodiment, configuration information of the target sub-band comprises at least one of location information of the target sub-band in frequency domain, a link direction indication of the target sub-band, a subcarrier spacing indication, a location of a starting PRB in a BWP to which the target sub-band belongs, a number of PRBs comprised, or an index or identifier of a BWP to which the target sub-band belongs.

In one embodiment, configuration information of the target sub-band comprises at least one of location information of the target sub-band in frequency domain, a link direction indication of the target sub-band, a subcarrier spacing indication, a location of a starting PRB in a BWP to which it belongs, a location of an ending PRB in a BWP to which it belongs, an index or identifier of a BWP to which a starting PRB belongs, or an index or identifier of a BWP to which an ending PRB belongs.

In one embodiment, configuration information of the target sub-band is configured by the target sub-band dedicated signaling.

In one embodiment, configuration information of the target sub-band is configured by a signaling that is dedicated to a sub-band group to which the target sub-band belongs.

In one embodiment, configuration information of the target sub-band is configured by a configuration signaling configured per sub-band.

In one embodiment, the expression in the claim that configuration information of the target sub-band is used to determine a slot format for the target sub-band comprises the following meaning: configuration information of the target sub-band is used by the first node in the present application to at least determine a slot format for the target sub-band.

In one embodiment, the expression in the claim that configuration information of the target sub-band is used to determine a slot format for the target sub-band comprises the following meaning: partial or all of configuration information of the target sub-band is used to explicitly or implicitly indicate a slot format for the target sub-band.

In one embodiment, the expression in the claim that configuration information of the target sub-band is used to determine a slot format for the target sub-band comprises the following meaning: configuration information of the target sub-band comprises an indication of whether the target sub-band is a flexible or a sub-band with variable link direction, and an indication of whether the target sub-band is a flexible or a sub-band with variable link direction is used to determine a slot format for the target sub-band.

In one embodiment, the expression in the claim that configuration information of the target sub-band is used to determine a slot format for the target sub-band comprises the following meaning: configuration information of the target sub-band comprises an indication of whether a link direction of a time-domain symbol configured by an IE “tdd-UL-DL-ConfigCommon” as uplink or downlink is supported to be overridden, and an indication of whether a link direction of a time-domain symbol configured by an IE “tdd-UL-DL-ConfigCommon” as uplink or downlink is supported to be overridden is used to determine a slot format for the target sub-band.

In one embodiment, the expression in the claim that configuration information of the target sub-band is used to determine a slot format for the target sub-band comprises the following meaning: configuration information of the target sub-band comprises an indication of whether a link direction of a time-domain symbol configured by an IE “tdd-UL-DL-ConfigDedicated” as uplink or downlink is supported to be overridden, and an indication of whether a link direction of a time-domain symbol configured by an IE “tdd-UL-DL-ConfigDedicated” as uplink or downlink is supported to be overridden is used to determine a slot format for the target sub-band.

In one embodiment, the expression in the claim that configuration information of the target sub-band is used to determine a slot format for the target sub-band comprises the following meaning: configuration information of the target sub-band comprises whether the target sub-band belongs to an indication supporting multiple link directions, and whether the target sub-band belongs to an indication supporting multiple link directions is used to determine a slot format for the target sub-band.

In one embodiment, a slot format for the target sub-band comprises a slot format applicable to the target sub-band.

In one embodiment, a slot format for the target sub-band comprises a slot format in time domain conformed to by a transmission of a channel or signal whose occupied frequency-domain resources belong to the target sub-band.

In one embodiment, a slot format for the target sub-band comprises a slot format configured with the target sub-band specific or dedicated configuration information.

In one embodiment, a slot format for the target sub-band comprises that at least one subcarrier occupied in frequency domain belongs to a slot format satisfied by a time-domain symbol occupied in time domain by a transmission of the target sub-band.

In one embodiment, a slot format for the target sub-band comprises that at least one subcarrier occupied in frequency domain belongs to a link direction satisfied by a time-domain symbol occupied in time domain by a transmission of the target sub-band.

In one embodiment, a slot format for the target sub-band comprises a slot format satisfied by a link direction of a time-domain symbol occupied by a channel or signal in time domain at least having one overlapped subcarrier with the target sub-band in frequency domain.

In one embodiment, a slot format for the target sub-band is specific or dedicated to the target sub-band.

In one embodiment, a slot format for sub-bands other than the target sub-band may be the same or different from a slot format for the target sub-band.

In one embodiment, whether a slot format for a sub-band other than the target sub-band is the same as a slot format for the target sub-band is determined by the network side configuration.

In one embodiment, a slot format for the target sub-band comprises all slot formats for the target sub-band.

In one embodiment, a slot format for the target sub-band comprises any slot format for the target sub-band.

In one embodiment, a slot format for the target sub-band is “D”, indicating that the target sub-band is only configured for downlink transmission; a slot format for the target sub-band is “U”, indicating that the target sub-band is only configured for uplink transmission; a slot format for the target sub-band is “F”, indicating that the target sub-band can only be configured for downlink transmission and can also be configured for uplink transmission.

In one subembodiment of the above embodiment, a slot format of the above target sub-band is specific to the first node.

In one subembodiment of the above embodiment, a slot format of the above target sub-band is specific to the second node in the present application.

In one embodiment, the slot format comprises a number of uplink time-domain symbols in a slot and a number of downlink time-domain symbols.

In one embodiment, the slot format comprises a number of uplink time-domain symbols in a slot and a number of downlink time-domain symbols and arrangement order of uplink and downlink time-domain symbols.

In one embodiment, the slot format is a distribution pattern of uplink and downlink time-domain symbols and flexible time-domain symbols.

In one embodiment, the slot format is a distribution pattern of uplink and downlink time-domain symbols and flexible time-domain symbols within a time period.

In one embodiment, the slot format is a distribution pattern of uplink and downlink time-domain symbols and flexible time-domain symbols within a time period, and the distribution pattern is repeated periodically in time domain.

In one embodiment, the slot format comprises a number of uplink time-domain symbols in a slot and a distribution pattern of downlink time-domain symbols.

In one embodiment, the slot format comprises a number of and a distribution pattern of uplink and downlink time-domain symbols in a slot.

In one embodiment, the slot format comprises a distribution pattern of uplink and downlink time-domain symbols and flexible time-domain symbols in a target time window.

In one subembodiment of the above embodiment, the target time window is a slot.

In one subembodiment of the above embodiment, the target time window is a sub-frame.

In one subembodiment of the above embodiment, the target time window are two frames.

In one subembodiment of the above embodiment, the target time window is predefined.

In one subembodiment of the above embodiment, the target time window is explicitly or implicitly configured.

In one subembodiment of the above embodiment, distribution patterns of uplink and downlink time-domain symbols and flexible time-domain symbols in the target time window are periodically repeated.

In one embodiment, time-domain symbols other than uplink and downlink time-domain symbols in a slot format are flexible time-domain symbols.

In one embodiment, the first signaling comprises higher-layer information or higher-layer parameter configurations.

In one embodiment, the first signaling comprises one or more Information Elements (IEs) comprised in a Radio Resource Control (RRC) layer signaling, or the first information block comprises one or more fields comprised in an RRC layer signaling.

In one embodiment, the first signaling comprises configuration of physical-layer information or physical-layer parameters.

In one embodiment, the first signaling comprises one or multiple fields in a DCI format.

In one embodiment, the first signaling is transmitted through a PDCCH.

In one embodiment, the operating action is receiving, and the first signaling is a downlink grant.

In one embodiment, the operating action is transmitting, and the first signaling is an uplink grant.

In one embodiment, the first signaling is a MAC CE.

In one embodiment, a physical-layer channel occupied by the first signaling comprises a Physical Downlink Shared Channel (PDSCH).

In one embodiment, the first signaling is an RRC signaling.

In one embodiment, the first signaling comprises an IE “ConfiguredGrantConfig”.

In one embodiment, the first signaling comprises an IE “SPS-Config”.

In one embodiment, the operating action is receiving, the first signal is used to activate a Semi-Persistent Scheduling (SPS) configuration, and the first signal belongs to a downlink arrangement of the SPS configured grant.

In one embodiment, the operating action is transmitting, the first signaling is used to activate a configured grant, and the first signal is an uplink grant belonging to the configured grant.

In one embodiment, the first reference signal resource comprises Channel-State Information Reference Signal (CSI-RS) resources.

In one embodiment, the first reference signal resource comprises Demodulation Reference Signal (DMRS) resources.

In one embodiment, the first reference signal resource comprises Sounding Reference Signal (SRS) resources.

In one embodiment, the first reference signal resource comprises an SS/PBCH Block (SSB).

In one embodiment, the first reference signal resource corresponds to a TCI.

In one embodiment, the first reference signal resource corresponds to a TCI-State.

In one embodiment, the first reference signal resource corresponds to a TCI-StateId.

In one embodiment, the first reference signal resource corresponds to an SRI.

In one embodiment, the first time-frequency resource set occupies more than one positive integer number of REs.

In one embodiment, the first signal is a baseband signal.

In one embodiment, the first signal is a radio signal.

In one embodiment, the operating action is receiving, and a physical-layer channel occupied by the first signal comprises a PDSCH.

In one embodiment, the operating action is receiving, and a transmission channel occupied by the first signal comprises a DL-SCH (Downlink Shared Channel).

In one embodiment, the operating action is transmitting, and a physical-layer channel occupied by the first signal comprises a PUSCH (Physical Uplink Shared Channel).

In one embodiment, the operating action is transmitting, and a transmission channel occupied by the first signal comprises an Uplink Shared Channel (UL-SCH).

In one embodiment, the operating action is receiving, and spatial parameters of the first signal are spatial parameters of a demodulation reference signal of a channel occupied by the first signal.

In one embodiment, the operating action is receiving, and the spatial parameters are QCL parameters.

In one embodiment, the operating action is receiving, and the spatial parameters are spatial reception parameters.

In one embodiment, the operating action is receiving, and the spatial parameters are spatial domain reception filters.

In one embodiment, the operating action is receiving, and the meaning that the first reference signal resource is used to determine spatial parameters of the first signal comprises: a demodulation reference signal of a signal occupied by the first signal and the first reference signal resource are QCL (Quasi Co-located).

In one embodiment, the operating action is transmitting, and the spatial parameters are spatial transmission parameters.

In one embodiment, the operating action is transmitting, and the spatial parameters are spatial domain transmission filters.

In one embodiment, the operating action is transmitting, and the spatial parameters are spatial relations.

In one embodiment, the operating action is transmitting, and the spatial parameters comprise pre-coder.

In one embodiment, the operating action is transmitting, the meaning of the phrase that the first reference signal resource is used to determine spatial parameters of the first signal comprises: transmission precoding of the first signal is determined by the first reference signal resource.

In one embodiment, a type of the QCL in the present application comprises QCL Type A.

In one embodiment, a type of the QCL in the present application comprises QCL Type B.

In one embodiment, a type of the QCL in the present application comprises QCL Type C.

In one embodiment, a type of the QCL in the present application comprises QCL Type D.

In one embodiment, the first signaling is used to indicate time-domain resources occupied by the first time-frequency resource set.

In one embodiment, the first signaling is used to indicate a number of symbols occupied by the first time-frequency resource set.

In one embodiment, the first signaling is used to indicate a time-domain location of a first one of symbols occupied by the first time-frequency resource set.

In one embodiment, the first signaling is used to indicate frequency-domain resources occupied by the first time-frequency resource set.

In one embodiment, the first signaling is used to indicate a frequency-domain location of an RB occupied by the first time-frequency resource set.

In one embodiment, any one of the K1 candidate reference signal resources comprises at least one of CSI-RS resources or an SSB.

In one embodiment, any one of the K1 candidate reference signal resources comprises DMRS resources.

In one embodiment, any one of the K1 candidate reference signal resources comprises SRS resources.

In one embodiment, any one of the K1 candidate reference signal resources corresponds to a TCI.

In one embodiment, any one of the K1 candidate reference signal resources corresponds to a TCI-State.

In one embodiment, any one of the K1 candidate reference signal resources corresponds to a TCI-StateId.

In one embodiment, any one of the K1 candidate reference signal resources corresponds to an SRI.

In one embodiment, the first signaling comprises a first field, and the first field comprised in the first signaling indicates the first reference signal resource from the K1 candidate reference signal resources.

In one subembodiment of the embodiment, the operating action is receiving, the first signaling is a PDCCH, and the first field comprised in the first signaling is a TCI field.

In one subembodiment of the embodiment, the operating action is transmitting, the first signaling is a PDCCH, and the first field comprised in the first signaling is an SRI field.

In one embodiment, the operating action is receiving, and the first signaling is a TCI States Activation/Activation for UE specific PDSCH MAC CE.

In one embodiment, the operating action is transmitting, and the first signaling is a Serving Cell Set Based Spatial Relation Indication MAC CE.

In one embodiment, the target reference signal resource set corresponds to a TCI list, the TCI list comprises K1 TCIs, and the K1 TCIs respectively correspond to K1 candidate reference signal resources.

In one embodiment, the target reference signal resource set corresponds to an SRI list, the SRI list comprises K1 TCIs, and the K1 SRIs respectively correspond to K1 candidate reference signal resources.

In one embodiment, the M1 reference signal resource sets respectively correspond to M1 TCI lists.

In one embodiment, the M1 reference signal resource sets respectively correspond to M1 SRI lists.

In one embodiment, any one of the M1 reference signal resource sets comprises at least one reference signal resource, and the reference signal resource comprises at least one of CSI-RS resources, SSB, DMRS resources, or SRS resources.

In one embodiment, any one of the M1 reference signal resource sets comprises at least one reference signal resource, and the reference signal resource corresponds to a TCI.

In one embodiment, any one of the M1 reference signal resource sets comprises at least one reference signal resource, and the reference signal resource corresponds to a TCI-State.

In one embodiment, any one of the M1 reference signal resource sets comprises at least one reference signal resource, and the reference signal resource corresponds to a TCI-StateId.

In one embodiment, any one of the M1 reference signal resource sets comprises at least one reference signal resource, and the reference signal resource corresponds to an SRI.

In one embodiment, a relation between the first time-frequency resource set and the target sub-band comprises: whether the first time-frequency resource set belongs to the target sub-band in frequency domain.

In one embodiment, a relation between the first time-frequency resource set and the target sub-band comprises: whether the first time-frequency resource set is orthogonal to the target sub-band in frequency domain.

In one embodiment, a relation between the first time-frequency resource set and the target sub-band comprises: whether there exists at least one overlapped subcarrier between the first time-frequency resource set in frequency domain and the target sub-band.

In one embodiment, a relation between the first time-frequency resource set and the target sub-band comprises: whether there exists at least one overlapped resource block between the first time-frequency resource set in frequency domain and the target sub-band.

In one embodiment, a relation between the first time-frequency resource set and the target sub-band comprises: whether each resource block comprised in the first time-frequency resource set in frequency domain belongs to the target sub-band.

In one embodiment, the first time-frequency resource set belongs to the target sub-band in frequency domain, and a relation between the first time-frequency resource set and the target sub-band comprises: a location of a resource block comprised in the first time-frequency resource set in frequency domain in the target sub-band.

In one embodiment, the first time-frequency resource set belongs to the target sub-band in frequency domain, and a relation between the first time-frequency resource set and the target sub-band comprises: a distribution of a resource block comprised in the first time-frequency resource set in frequency domain in the target sub-band.

In one embodiment, a relation between the first time-frequency resource set and the target sub-band comprises: whether the first time-frequency resource set belongs to the target sub-band in frequency domain, and a location of a resource block comprised in frequency domain in the target sub-band when the first time-frequency resource set belongs to the target sub-band in frequency domain.

In one embodiment, a relation between the first time-frequency resource set and the target sub-band comprises: whether the first time-frequency resource set belongs to the target sub-band in frequency domain, and whether the first time-frequency resource set comprises a subcarrier located in the first frequency interval or the second frequency interval in the present application when the first time-frequency resource set does not belong to the target sub-band in frequency domain.

In one embodiment, a relation between the first time-frequency resource set and the target sub-band comprises: whether the first time-frequency resource set comprises a subcarrier located in the first frequency interval or the second frequency interval of the present application in frequency domain.

In one embodiment, the M1 reference signal resource sets comprise a first reference signal resource set and a second reference signal resource set.

In one subembodiment of the embodiment, the operating action is receiving.

In one subembodiment of the embodiment, the first reference signal resource set is different from the second reference signal resource set.

In one subembodiment of the embodiment, the first reference signal resource set and the second reference signal resource set are configured to be used for downlink transmission.

In one subsidiary embodiment of the subembodiment, the first reference signal resource set comprises N1 reference signal resources, and the second reference signal resource set comprises N2 reference signal resources; there at least exists TCI-StateId corresponding to one reference signal resource among the N1 reference signal resources being different from TCI-StateId corresponding to any reference signal resource among the N2 reference signal resources; N1 and N2 are both positive integers greater than 1.

In one embodiment, the M1 reference signal resource sets comprise a third reference signal resource set and a fourth reference signal resource set.

In one subembodiment of the embodiment, the operating action is transmitting.

In one subembodiment of the embodiment, the third reference signal resource set and the fourth reference signal resource set are configured to be used for uplink transmission.

In one subsidiary embodiment of the subembodiment, the third reference signal resource set comprises N3 reference signal resources, and the fourth reference signal resource set comprises N4 reference signal resources; there at least exists an SRI corresponding to one reference signal resource among the N3 reference signal resources being different from an SRI corresponding to any reference signal resource among the N4 reference signal resources; N3 and N4 are both positive integers greater than 1.

In one embodiment, the expression in the claim that at least one of a relation between the first time-frequency resource set and the target sub-band, or configuration information of the target sub-band is used to determine the target reference signal resource set from the M1 reference signal resource sets comprises the following meaning: at least one of a relation between the first time-frequency resource set and the target sub-band, or configuration information of the target sub-band is used by the first node in the present application to determine the target reference signal resource set from the M1 reference signal resource sets.

In one embodiment, the expression in the claim that at least one of a relation between the first time-frequency resource set and the target sub-band, or configuration information of the target sub-band is used to determine the target reference signal resource set from the M1 reference signal resource sets comprises the following meaning: a relation between the first time-frequency resource set and the target sub-band is used to determine the target reference signal resource set from the M1 reference signal resource sets.

In one subembodiment of the embodiment, the first time-frequency resource set belongs to the target sub-band in frequency domain, and the target reference signal resource set is the first reference signal resource set; or, the first time-frequency resource set does not belong to the target sub-band in frequency domain, and the target reference signal resource set is the second reference signal resource set.

In one subembodiment of the embodiment, the first time-frequency resource set belongs to the target sub-band in frequency domain, and the target reference signal resource set is the third reference signal resource set; or, the first time-frequency resource set does not belong to the target sub-band in frequency domain, and the target reference signal resource set is the fourth reference signal resource set.

In one subembodiment of the embodiment, the first time-frequency resource set is orthogonal to the target sub-band in frequency domain, and the target reference signal resource set is the second reference signal resource set; or the first time-frequency resource set is not orthogonal to the target sub-band in frequency domain, and the target reference signal resource set is the first reference signal resource set.

In one subembodiment of the embodiment, the first time-frequency resource set is orthogonal to the target sub-band in frequency domain, and the target reference signal resource set is the fourth reference signal resource set; or the first time-frequency resource set is not orthogonal to the target sub-band in frequency domain, and the target reference signal resource set is the third reference signal resource set.

In one subembodiment of the embodiment, there exists at least one overlapped subcarrier between the first time-frequency resource set in frequency domain and the target sub-band, and the target reference signal resource set is the first reference signal resource set; or there does not exist at least one overlapped subcarrier between the first time-frequency resource set in frequency domain and the target sub-band, and the target reference signal resource set is the second reference signal resource set.

In one subembodiment of the embodiment, there exists at least one overlapped subcarrier between the first time-frequency resource set in frequency domain and the target sub-band, and the target reference signal resource set is the third reference signal resource set; or there does not exist any overlapped subcarrier between the first time-frequency resource set in frequency domain and the target sub-band, and the target reference signal resource set is the fourth reference signal resource set.

In one subembodiment of the embodiment, each resource block comprised in the first time-frequency resource set belongs to the target sub-band in frequency domain, and the target reference signal resource set is the first reference signal resource set; or there exists one resource block in all resource blocks comprised in the first time-frequency resource set in frequency domain not belonging to the target sub-band, and the target reference signal resource set is the second reference signal resource set.

In one subembodiment of the embodiment, each resource block comprised in the first time-frequency resource set in frequency domain belongs to the target sub-band, and the target reference signal resource set is the third reference signal resource set; or there exists one resource block in all resource blocks comprised in the first time-frequency resource set in frequency domain not belonging to the target sub-band, and the target reference signal resource set is the fourth reference signal resource set.

In one subembodiment of the embodiment, the first time-frequency resource set belongs to the target sub-band in frequency domain; a resource block comprised in frequency domain of the first time-frequency resource set are located at a center location in the target sub-band, and the target reference signal resource set is the first reference signal resource set; or a resource block comprised in frequency domain of the first time-frequency resource set is located at an edge location in the target sub-band, and the target reference signal resource set is the second reference signal resource set.

In one embodiment, the expression in the claim that at least one of a relation between the first time-frequency resource set and the target sub-band, or configuration information of the target sub-band is used to determine the target reference signal resource set from the M1 reference signal resource sets comprises the following meaning: configuration information of the target sub-band is used to determine the target reference signal resource set from the M1 reference signal resource sets.

In one subembodiment of the embodiment, the target sub-band supports full duplex type or a sub-band set to which the target sub-band belongs supports full duplex type, and the target reference signal resource set is the first reference signal resource set; the target sub-band does not support full duplex type or a sub-band set to which the target sub-band belongs does not support full duplex type, and the target reference signal resource set is the second reference signal resource set.

In one subembodiment of the embodiment, the target sub-band supports full duplex type or a sub-band set to which the target sub-band belongs supports full duplex type, and the target reference signal resource set is the third reference signal resource set; the target sub-band does not support full duplex type or a sub-band set to which the target sub-band belongs does not support full duplex type, and the target reference signal resource set is the fourth reference signal resource set.

In one subembodiment of the embodiment, the target sub-band supports multiple link directions, and the target reference signal resource set is the first reference signal resource set; the target sub-band does not support multiple link directions, and the target reference signal resource set is the second reference signal resource set.

In one subembodiment of the embodiment, the target sub-band supports multiple link directions, and the target reference signal resource set is the third reference signal resource set; the target sub-band does not support multiple link directions, and the target reference signal resource set is the fourth reference signal resource set.

In one subembodiment of the embodiment, the target sub-band belongs to a sub-band set that support multiple link directions, and the target reference signal resource set is the first reference signal resource set; the target sub-band does not belong to a sub-band set that support multiple link directions, and the target reference signal resource set is the second reference signal resource set.

In one subembodiment of the embodiment, the target sub-band belongs to a sub-band set that support multiple link directions, and the target reference signal resource set is the third reference signal resource set; the target sub-band does not belong to a sub-band set that support multiple link directions, and the target reference signal resource set is the fourth reference signal resource set.

In one subembodiment of the embodiment, the target sub-band belongs to a BWP that support multiple link directions, and the target reference signal resource set is the first reference signal resource set; the target sub-band does not belong to a BWP that support multiple link directions, and the target reference signal resource set is the second reference signal resource set.

In one subembodiment of the embodiment, the target sub-band belongs to a BWP that support multiple link directions, and the target reference signal resource set is the third reference signal resource set; the target sub-band does not belong to a BWP that support multiple link directions, and the target reference signal resource set is the fourth reference signal resource set.

In one subembodiment of the embodiment, the target sub-band is a sub-band with flexible or variable link direction, or the target sub-band belongs to a sub-band set with flexible link (FL) or variable link (VL) direction, and the target reference signal resource set is the first reference signal resource set; or, the target sub-band is not a sub-band with flexible or variable link direction, or the target sub-band does not belong to a sub-band set with flexible or variable link direction, and the target reference signal resource set is the second reference signal resource set.

In one subembodiment of the embodiment, the target sub-band is a sub-band with flexible or variable link direction, or the target sub-band belongs to a sub-band set with flexible link (FL) or variable link (VL) direction, and the target reference signal resource set is the third reference signal resource set; or, the target sub-band is not a sub-band with flexible or variable link direction, or the target sub-band does not belong to a sub-band set with flexible or variable link direction, and the target reference signal resource set is the fourth reference signal resource set.

In one subembodiment of the embodiment, the target sub-band is a BWP with flexible or variable link direction, or the target sub-band belongs to a BWP set with flexible link (FL) or variable link (VL) direction, and the target reference signal resource set is the first reference signal resource set; or, the target sub-band is not a BWP with flexible or variable link direction, or the target sub-band does not belong to a BWP set with flexible or variable link direction, and the target reference signal resource set is the second reference signal resource set.

In one subembodiment of the embodiment, the target sub-band is a BWP with flexible or variable link direction, or the target sub-band belongs to a BWP set with flexible link (FL) or variable link (VL) direction, and the target reference signal resource set is the third reference signal resource set; or, the target sub-band is not a BWP with flexible or variable link direction, or the target sub-band does not belong to a BWP set with flexible or variable link direction, and the target reference signal resource set is the fourth reference signal resource set.

In one subembodiment of the embodiment, the target sub-band supports a link direction of a time-domain symbol configured by an IE “tdd-UL-DL-ConfigCommon” as uplink or downlink being overridden, and the target reference signal resource set is the first reference signal resource set; or, the target sub-band does not support a link direction of a time-domain symbol configured by an IE “tdd-UL-DL-ConfigCommon” as uplink or downlink being overridden, and the target reference signal resource set is the second reference signal resource set.

In one subembodiment of the embodiment, the target sub-band supports a link direction of a time-domain symbol configured by an IE “tdd-UL-DL-ConfigCommon” as uplink or downlink being overridden, and the target reference signal resource set is the third reference signal resource set; or, the target sub-band does not support a link direction of a time-domain symbol configured by an IE “tdd-UL-DL-ConfigCommon” as uplink or downlink being overridden, and the target reference signal resource set is the fourth reference signal resource set.

In one subembodiment of the embodiment, the target sub-band supports a link direction of a time-domain symbol configured by an IE “tdd-UL-DL-ConfigDedicated” as uplink or downlink being overridden, and the target reference signal resource set is the first reference signal resource set; or, the target sub-band does not support a link direction of a time-domain symbol configured by an IE “tdd-UL-DL-ConfigDedicated” as uplink or downlink being overridden, and the target reference signal resource set is the second reference signal resource set.

In one subembodiment of the embodiment, the target sub-band supports a link direction of a time-domain symbol configured by an IE “tdd-UL-DL-ConfigDedicated” as uplink or downlink being overridden, and the target reference signal resource set is the third reference signal resource set; or, the target sub-band does not support a link direction of a time-domain symbol configured by an IE “tdd-UL-DL-ConfigDedicated” as uplink or downlink being overridden, and the target reference signal resource set is the fourth reference signal resource set.

In one embodiment, the expression in the claim that at least one of a relation between the first time-frequency resource set and the target sub-band, or configuration information of the target sub-band is used to determine the target reference signal resource set from the M1 reference signal resource sets comprises the following meaning: a relation between the first time-frequency resource set and the target sub-band, as well as configuration information of the target sub-band, are jointly used by the first node in the present application to determine the target reference signal resource set from the M1 reference signal resource sets.

In one subembodiment of the embodiment, the first time-frequency resource set belongs to the target sub-band in frequency domain, and the target sub-band is a sub-band with flexible or variable link direction, and the target reference signal resource set is the first reference signal resource set; otherwise, the target reference signal resource set is the second reference signal resource set.

In one subembodiment of the embodiment, the first time-frequency resource set belongs to the target sub-band in frequency domain, and the target sub-band is a sub-band with flexible or variable link direction, and the target reference signal resource set is the third reference signal resource set; otherwise, the target reference signal resource set is the fourth reference signal resource set.

In one subembodiment of the embodiment, there at least exists an overlapped subcarrier between the first time-frequency resource set in frequency domain and the target sub-band, the target sub-band is a sub-band with flexible or variable link direction, and the target reference signal resource set is the first reference signal resource set; otherwise, the target reference signal resource set is the second reference signal resource set.

In one subembodiment of the embodiment, there at least exists an overlapped subcarrier between the first time-frequency resource set in frequency domain and the target sub-band, the target sub-band is a sub-band with flexible or variable link direction, and the target reference signal resource set is the third reference signal resource set; otherwise, the target reference signal resource set is the fourth reference signal resource set.

In one subembodiment of the embodiment, the first time-frequency resource set belongs to the target sub-band in frequency domain, the target sub-band supports a link direction of a time-domain symbol configured by an IE “tdd-UL-DL-ConfigCommon” or an IE “tdd-UL-DL-ConfigDedicated” as uplink or downlink being overridden, and the target reference signal resource set is the first reference signal resource set; otherwise, the target reference signal resource set is the second reference signal resource set.

In one subembodiment of the embodiment, the first time-frequency resource set belongs to the target sub-band in frequency domain, the target sub-band supports a link direction of a time-domain symbol configured by an IE “tdd-UL-DL-ConfigCommon” or an IE “tdd-UL-DL-ConfigDedicated” as uplink or downlink being overridden, and the target reference signal resource set is the third reference signal resource set; otherwise, the target reference signal resource set is the fourth reference signal resource set.

In one subembodiment of the embodiment, there at least exists one overlapped subcarrier between the first time-frequency resource set in frequency domain and the target sub-band, the target sub-band supports a link direction of a time-domain symbol configured by an IE “tdd-UL-DL-ConfigCommon” or an IE “tdd-UL-DL-ConfigDedicated” as uplink or downlink being overridden, and the target reference signal resource set is the first reference signal resource set; otherwise, the target reference signal resource set is the second reference signal resource set.

In one subembodiment of the embodiment, there exists at least one overlapped subcarrier between the first time-frequency resource set in frequency domain and the target sub-band, the target sub-band supports a link direction of a time-domain symbol configured by an IE “tdd-UL-DL-ConfigCommon” or an IE “tdd-UL-DL-ConfigDedicated” as uplink or downlink being overridden,, and the target reference signal resource set is the third reference signal resource set; otherwise, the target reference signal resource set is the fourth reference signal resource set.

In one embodiment, the symbol in the present application is an Orthogonal Frequency Division Multiplexing (OFDM) symbol.

In one embodiment, the symbol in the present application is a Single Carrier-Frequency Division Multiple Access (SC-FDMA) symbol.

In one embodiment, the symbol in the present application is a Filter Bank Multi Carrier (FBMC) symbol.

In one embodiment, the symbol in the present application is an OFDM symbol that comprises a Cyclic Prefix (CP).

In one embodiment, the symbol in the present application is a Discrete Fourier Transform Spreading Orthogonal Frequency Division Multiplexing (DFT-s-OFDM) symbol that comprises a CP.

In one subembodiment of the above embodiment, under the condition of extending the cyclic prefix, W1 is equal to 12.

In one embodiment, the first signal is generated by a Transport Block (TB).

In one embodiment, the first signal is generated by a Code Block (CB).

In one embodiment, the first signal is generated by a Code Block Group (CBG).

In one embodiment, the first signaling is used to schedule the first signal.

In one embodiment, the operating action is receiving, the first signal is used to activate a Semi Persistent Scheduling (SPS) configuration, and the first signal belongs to a downlink arrangement of the SPS configured grant.

In one embodiment, the operating action is transmitting, the first signaling is used to activate a configured grant, and the first signal is an uplink grant belonging to the configured grant.

In one embodiment, the slot format in the present application refers to: a slot format adopted by a symbol in the slot.

In one embodiment, the slot format in the present application refers to: a transmission direction corresponding to symbols in the slot.

In one embodiment, the slot format in the present application refers to: a transmission direction corresponding to the symbol in the slot is one of “downlink”, “uplink” or “flexible”.

In one embodiment, the slot format in the present application refers to: a transmission direction corresponding to the slot.

In one embodiment, the slot format in the present application refers to: a transmission direction corresponding to the slot is one of “downlink”, “uplink” or “flexible”.

### Embodiment 2

Embodiment 2 illustrates a schematic diagram of a network architecture, as shown in FIG. 2.

FIG. 2 illustrates a network architecture 200 of 5G NR, Long-Term Evolution (LTE) and Long-Term Evolution Advanced (LTE-A) systems. The NR 5G or LTE network architecture 200 may be called an Evolved Packet System (EPS) 200 or other appropriate terms. The EPS 200 may comprise UE 201, an NR-RAN 202, an Evolved Packet Core/5G-Core Network (EPC/5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will readily understand that various concepts presented throughout the present application can be extended to networks providing circuit switching services or other cellular networks. The NR-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPSs), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 comprises a Mobility Management Entity (MME)/Authentication Management Field (AMF)/User Plane Function (UPF) 211, other MMEs/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212, the S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the UE 201 corresponds to the first node in the present application.

In one embodiment, the UE 201 supports Unpaired Spectrum scenario.

In one embodiment, the UE 201 supports Flexible Duplex frequency-domain resource configuration.

In one embodiment, the UE 201 supports Full Duplex transmission.

In one embodiment, the UE 201 supports dynamically adjusting uplink and downlink transmission directions.

In one embodiment, the gNB 203 corresponds to the second node in the present application.

In one embodiment, the gNB 203 supports Unpaired Spectrum scenario.

In one embodiment, the gNB 203 supports Flexible Duplex frequency-domain resource configuration.

In one embodiment, the gNB 203 supports Full Duplex transmission.

In one embodiment, the gNB 203 supports dynamically adjusting uplink and downlink transmission directions.

### Embodiment 3

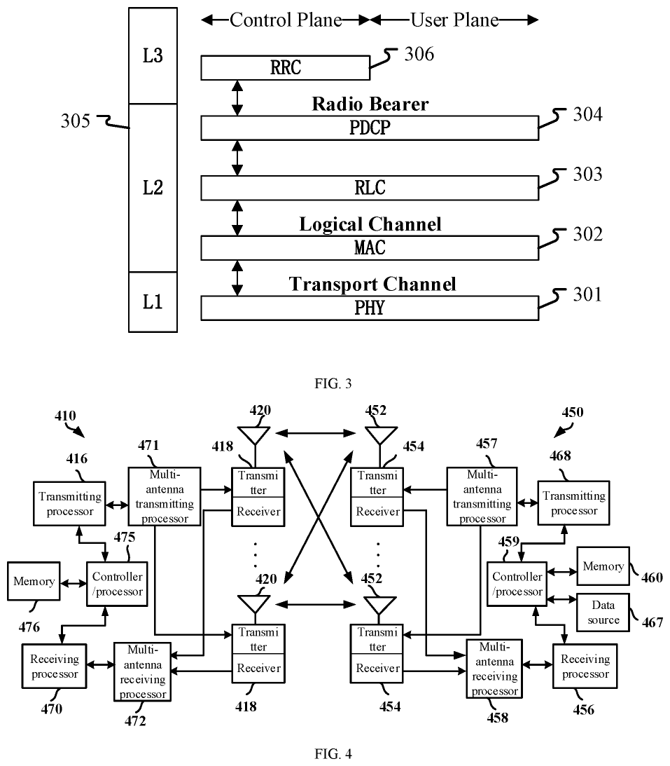

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first communication node (UE, gNB or an RSU in V2X) and a second communication node (gNB, UE or an RSU in V2X) is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of the link between the first communication node and the second communication node via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication node. The PDCP sublayer 304 provides multiplexing among variable radio bearers and logical channels. The PDCP sublayer 304 provides security by encrypting a packet and also provides support for a first communication node handover between second communication nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second communication node and a first communication node device. The radio protocol architecture of the user plane 350 comprises layer 1 (L1) and layer 2 (L2). In the user plane 350, the radio protocol architecture for the first communication node and the second communication node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first communication node may comprise several higher layers above the L2 layer 355, such as a network layer (e.g., IP layer) terminated at a P-GW of the network side and an application layer terminated at the other side of the connection (e.g., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the PDCP 304 of the second communication node is used for generating scheduling of the first communication node.

In one embodiment, the PDCP 354 of the second communication node is used for generating scheduling of the first communication node.

In one embodiment, the first signaling is generated by the MAC 302 or the MAC 352.

In one embodiment, the first signaling is generated by the RRC 306.

In one embodiment, the first signaling is generated by the PHY 301 or the PHY 351.

In one embodiment, the first signal is generated by the PHY 301 or the PHY 351.

In one embodiment, the first signal is generated by the MAC 302 or the MAC 352.

In one embodiment, the first signal is generated by the RRC 306.

In one embodiment, the first information block is generated by the RRC 306.

In one embodiment, the first information block is generated by the MAC 302 or the MAC 352.

In one embodiment, the first information block is generated by the PHY 301 or the PHY 351.

In one embodiment, the second information block is generated by the RRC 306.

In one embodiment, the second information block is generated by the MAC 302 or the MAC 352.

In one embodiment, the first node is a terminal.

In one embodiment, the second node is a terminal.

In one embodiment, the second node is a Transmitter Receiver Point (TRP).

In one embodiment, the second node is a cell.

In one embodiment, the second node is an eNB.

In one embodiment, the second node is a base station.

In one embodiment, the second node is used to manage multiple TRPs.

In one embodiment, the second node is a node used for managing multiple cells.

In one embodiment, the second node is a node used for managing multiple carriers.

### Embodiment 4

Embodiment 4 illustrates a schematic diagram of a first communication device and a second communication device in the present application, as shown in FIG. 4. FIG. 4 is a block diagram of a first communication device 450 in communication with a second communication device 410 in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the first communication device 410, a higher layer packet from the core network is provided to a controller/processor 475. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transport channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first communication device 450 comprises: at least one processor and at least one memory. The at least one memory comprises computer program codes; the at least one memory and the computer program codes are configured to be used in collaboration with the at least one processor, the first communication device 450 at least: receives a first signaling, the first signaling is used to indicate a first reference signal resource; then operates a first signal in a first time-frequency resource set, the first reference signal resource is used to determine spatial parameters of the first signal; the first signaling is used to indicate the first time-frequency resource set; the first reference signal resource is one of K1 candidate reference signal resources, K1 is a positive integer greater than 1, and the first signaling indicates the first reference signal resource from the K1 candidate reference signal resources; a target reference signal resource set comprises K1 candidate reference signal resources, and the target reference signal resource set is one of M1 reference signal resource sets, where M1 is a positive integer greater than 1; time-domain resources occupied by the first time-frequency resource set are used to determine the target reference signal resource set from the M1 reference signal resource sets; the operating action is receiving, or, the operating action is transmitting.

In one embodiment, the first communication device 450 comprises at least one processor and at least one memory, a memory that stores a computer readable instruction program. The computer readable instruction program generates an action when executed by at least one processor. The action includes: first receiving a first signaling, the first signaling being used to indicate a first reference signal resource; then operating a first signal in a first time-frequency resource set, the first reference signal resource being used to determine spatial parameters of the first signal; the first signaling is used to indicate the first time-frequency resource set; the first reference signal resource is one of K1 candidate reference signal resources, K1 is a positive integer greater than 1, and the first signaling indicates the first reference signal resource from the K1 candidate reference signal resources; a target reference signal resource set comprises K1 candidate reference signal resources, and the target reference signal resource set is one of M1 reference signal resource sets, where M1 is a positive integer greater than 1; time-domain resources occupied by the first time-frequency resource set are used to determine the target reference signal resource set from the M1 reference signal resource sets; the operating action is receiving, or, the operating action is transmitting.

In one embodiment, the second communication device 410 comprises at least one processor and at least one memory. The at least one memory comprises computer program codes; the at least one memory and the computer program codes are configured to be used in collaboration with the at least one processor. The second communication device 410 at least: first transmits a first signaling, the first signaling is used to indicate a first reference signal resource; then executes a first signal in a first time-frequency resource set, the first reference signal resource is used to determine spatial parameters of the first signal; the first signaling is used to indicate the first time-frequency resource set; the first reference signal resource is one of K1 candidate reference signal resources, K1 is a positive integer greater than 1, and the first signaling indicates the first reference signal resource from the K1 candidate reference signal resources; a target reference signal resource set comprises K1 candidate reference signal resources, and the target reference signal resource set is one of M1 reference signal resource sets, where M1 is a positive integer greater than 1; time-domain resources occupied by the first time-frequency resource set are used to determine the target reference signal resource set from the M1 reference signal resource sets; the executing action is transmitting, or the executing action is receiving;

In one embodiment, the second communication device 410 comprises a memory that stores a computer readable instruction program. The computer readable instruction program generates an action when executed by at least one processor. The action includes: first transmitting a first signaling, the first signaling being used to indicate a first reference signal resource; then executing a first signal in a first time-frequency resource set, the first reference signal resource being used to determine spatial parameters of the first signal; the first signaling is used to indicate the first time-frequency resource set; the first reference signal resource is one of K1 candidate reference signal resources, K1 is a positive integer greater than 1, and the first signaling indicates the first reference signal resource from the K1 candidate reference signal resources; a target reference signal resource set comprises K1 candidate reference signal resources, and the target reference signal resource set is one of M1 reference signal resource sets, where M1 is a positive integer greater than 1; time-domain resources occupied by the first time-frequency resource set are used to determine the target reference signal resource set from the M1 reference signal resource sets; the executing action is transmitting, or the executing action is receiving.

In one embodiment, the first communication device 450 corresponds to a first node in the present application.

In one embodiment, the second communication device 410 corresponds to a second node in the present application.

In one embodiment, the first communication device 450 is a UE.

In one embodiment, the first communication device 450 is a terminal.

In one embodiment, the second communication device 410 is a base station.

In one embodiment, the second communication device 410 is a UE.

In one embodiment, the second communication device 410 is a network device.

In one embodiment, the second communication device 410 is a serving cell.

In one embodiment, the second communication device 410 is a TRP.

In one embodiment, at least first four of the antenna 452, the receiver 454, the multi-antenna receiving processor 458, the receiving processor 456 and the controller/processor 459 are used to receive a first signaling, and the first signaling is used to indicate a first reference signal resource; at least first four of the antenna 420, the transmitter 418, the multi-antenna transmitting processor 471, the transmitting processor 416 and the controller/processor 475 are used to transmit a first signaling, and the first signaling is used to indicate a first reference signal resource.

In one embodiment, at least first four of the antenna 452, the receiver 454, the multi-antenna receiving processor 458, the receiving processor 456 and the controller/processor 459 are used to receive a first signal in a first time-frequency resource set, and the first reference signal resource is used to determine spatial parameters of the first signal; at least first four of the antenna 420, the transmitter 418, the multi-antenna transmitting processor 471, the transmitting processor 416 and the controller/processor 475 are used to transmit a first signal in a first time-frequency resource set, and the first reference signal resource set is used to determine spatial parameters of the first signal.

In one embodiment, at least first four of the antenna 452, the transmitter 454, the multi-antenna transmitting processor 457, the transmitting processor 468, and the controller/processor 459 are used to transmit a first signal in a first time-frequency resource set, and the first reference signal resource is used to determine spatial parameters of the first signal; at least the first four of the antenna 420, the receiver 418, the multi-antenna receiving processor 472, the receiving processor 470, and the controller/processor 475 are used to receive a first signal in the first time-frequency resource set, and the first reference signal resource is used to determine spatial parameters of the first signal.

In one embodiment, at least first four of the antenna 452, the receiver 454, the multi-antenna receiving processor 458, the receiving processor 456 and the controller/processor 459 are used to receive a first information block; at least first four of the antenna 420, the transmitter 418, the multi-antenna transmitting processor 471, the transmitting processor 416 and the controller/processor 475 are used to transmit a first information block.

In one embodiment, at least first four of the antenna 452, the receiver 454, the multi-antenna receiving processor 458, the receiving processor 456 and the controller/processor 459 are used to receive a second information block; at least first four of the antenna 420, the transmitter 418, the multi-antenna transmitting processor 471, the transmitting processor 416 and the controller/processor 475 are used to transmit a second information block.

### Embodiment 5A

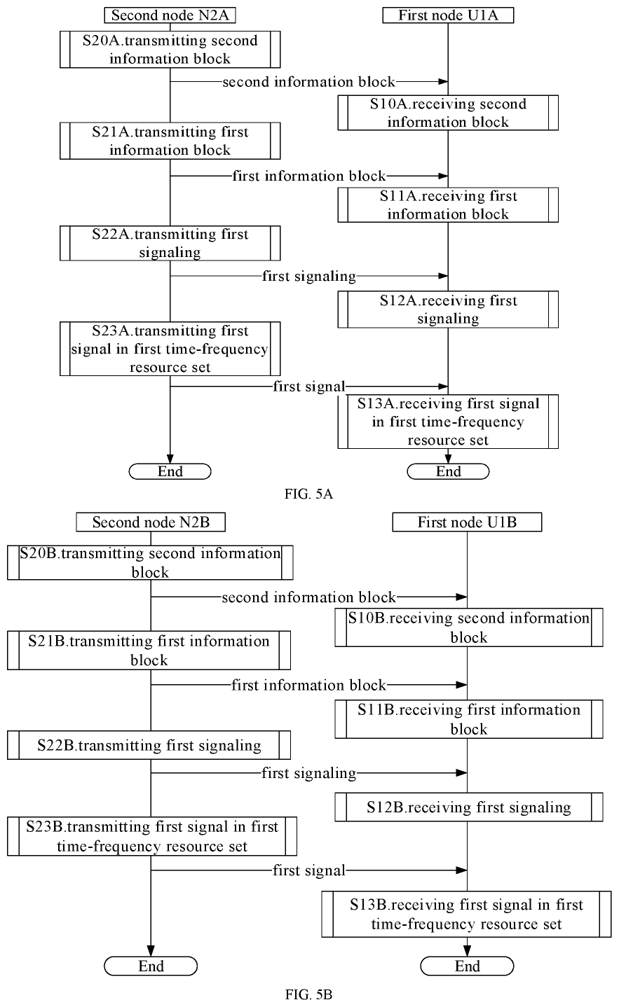

Embodiment 5A illustrates a flowchart of a first signaling, as shown in FIG. 5A. In FIG. 5A, a first node U1A and a second node N2A are in communications via a radio link. It is particularly underlined that the order illustrated in the embodiment does not put constraints over sequences of signal transmissions and implementations. Embodiments, sub-embodiments and subsidiary embodiments of embodiment 5A can be applied to embodiment 6A if no conflict is caused; on the contrary, embodiments, sub-embodiments and subsidiary embodiments in embodiment 6A can be applied to embodiment 5A without conflict.

The first node U1A receives a second information block in step S10A; receives a first information block in step S11A; receives a first signaling in step S12A; in step 13A, receives a first signal in a first time-frequency resource set.

The second node N2A transmits a second information block in step S20A; transmits a first information block in step S21A; transmits a first signaling in step S22A; transmits a first signal in a first time-frequency resource set in step S23A.

In embodiment 5A, the first reference signal resource is used to determine spatial parameters of the first signal; the first signaling is used to indicate the first time-frequency resource set; the first reference signal resource is one of K1 candidate reference signal resources, K1 is a positive integer greater than 1, and the first signaling indicates the first reference signal resource from the K1 candidate reference signal resources; a target reference signal resource set comprises K1 candidate reference signal resources, and the target reference signal resource set is one of M1 reference signal resource sets, where M1 is a positive integer greater than 1; time-domain resources occupied by the first time-frequency resource set are used to determine the target reference signal resource set from the M1 reference signal resource sets; the first information block is used to indicate a format adopted by a symbol comprised in the time-domain resources occupied by the first time-frequency resource set; the second information block is used to indicate the M1 reference signal resource sets.

In one embodiment, the M1 reference signal resource sets comprise a first reference signal resource set and a second reference signal resource set, and time-domain resources occupied by the first time-frequency resource set comprise a first symbol set; when a format adopted by a symbol in the first symbol set is a first format, the target reference signal resource set is the first reference signal resource set; when a format adopted by a symbol in the first symbol set is a second format, the target reference signal resource set is the second reference signal resource set; the first format and the second format are different.

In one subembodiment of the above embodiment, the first symbol set only comprises a symbol.

In one subembodiment of the above embodiment, the first symbol set comprises multiple symbols.

In one subembodiment of the embodiment, the meaning of the above phrase of a symbol in the first symbol set comprises: all symbols in the first symbol set.

In one subembodiment of the embodiment, the meaning of the above phrase of a symbol in the first symbol set comprises: any symbol in the first symbol set.

In one subembodiment of the embodiment, the meaning of the above phrase of a symbol in the first symbol set comprises: at least one symbol in the first symbol set.

In one subembodiment of the above embodiment, the first format is “D”, and the second format is “F”.

In one subembodiment of the embodiment, a format adopted by a symbol in the first symbol set is configured by a higher-layer signaling.

In one subembodiment of the embodiment, a format adopted by a symbol in the first symbol set is indicated by a DCI.

In one subembodiment of the embodiment, a format adopted by a symbol in the first symbol set is indicated by a MAC CE.

In one embodiment, the M1 reference signal resource sets comprise a first reference signal resource set and a second reference signal resource set, and time-domain resources occupied by the first time-frequency resource set belongs to a first time unit; when the first time unit is a time unit in a first time unit set, the target reference signal resource set is the first reference signal resource set; when the first time unit is a time unit in a second time unit set, the target reference signal resource set is the second reference signal resource set; a format of any time unit in the first time unit set is different from a format of any time unit in the second time unit set.

In one subembodiment of the embodiment, the first time unit is a slot.

In one subembodiment of the embodiment, the first time unit is a mini-slot.

In one subembodiment of the embodiment, the first time unit is a sub-slot.

In one subembodiment of the embodiment, the first time unit set comprises a positive integer number of time units greater than 1.

In one subembodiment of the embodiment, the second time unit set comprises a positive integer number of time units greater than 1.

In one subsidiary embodiment of the above two subembodiments, the time unit is a slot.

In one subsidiary embodiment of the above two subembodiments, the time unit is a mini-slot.

In one subsidiary embodiment of the above two subembodiments, the time unit is a sub-slot.

In one subembodiment of the embodiment, the first time unit set and the second time unit set are configured by higher layer.

In one subembodiment of the embodiment, the first time unit set and the second time unit set are indicated by a DCI.

In one subembodiment of the embodiment, a format of a symbol comprised in any time unit in the first time unit set is downlink, and a format of a symbol comprised in any time unit in the second time unit set is flexible; or the operating action is transmitting, a format of a symbol comprised in any time unit in the first time unit set is uplink, and a format of a symbol comprised in any time unit in the second time unit set is flexible.

In one embodiment, a format of any time unit in the first time unit set is “D”, and a format of any time unit in the second time unit set is “F”.

In one embodiment, the first node receives a radio signal from the base station in time-domain resources with format “D” in the present application, and the time-domain resources is not used by the first node to transmit a radio signal to the base station.

In one embodiment, the first node transmits a radio signal to the base station in time-domain resources with format “U” in the present application, and the time-domain resources is not used by the first node to receive a radio signal transmitted from the base station.

In one embodiment, the first node receives a radio signal from the base station in time-domain resources of format “F” in the present application, and the time-domain resources can be used by the first node to transmit a radio signal to the base station.

In one embodiment, the meaning that the format is “D” in the present application comprises: time-domain resources corresponding to the format are used for downlink transmission.

In one embodiment, the meaning that the format is “U” in the present application comprises: time-domain resources corresponding to the format are used for uplink transmission.

In one embodiment, the meaning that the format is “F” in the present application comprises: time-domain resources corresponding to the format can be used for both downlink and uplink transmission.

In one embodiment, the M1 reference signal resource sets are all configured to a first frequency band, and the first frequency band comprises frequency-domain resources occupied by the first time-frequency resource set.

In one embodiment, a reference time unit pool comprises a first time unit set and a second time unit set; a format of each time unit in the reference time unit pool is used to determine the first time unit set and the second time unit set.

In one subembodiment of the embodiment, when a format of a time unit in the reference time unit pool is “D”, the time unit belongs to the first time unit set; when a format of a time unit in the reference time unit pool is “F”, the time unit belongs to the second time unit set.

In one subembodiment of the embodiment, when a format of a time unit in the reference time unit pool is “U”, the time unit belongs to the first time unit set; when a format of a time unit in the reference time unit pool is “F”, the time unit belongs to the second time unit set.

In one embodiment, the M1 reference signal resource sets comprise a first reference signal resource set and a second reference signal resource set, and time-domain resources occupied by the first time-frequency resource set belongs to a first time unit; when the first time unit is a time unit in a first time unit set, the target reference signal resource set is the first reference signal resource set; when the first time unit is a time unit in a second time unit set, the target reference signal resource set is the second reference signal resource set; the first time unit set and the second time unit set are orthogonal.

In one embodiment, the M1 reference signal resource sets comprise a first reference signal resource set and a second reference signal resource set, and time-domain resources occupied by the first time-frequency resource set belongs to a first time unit; when the first time unit is a time unit in a first time unit set, the target reference signal resource set is the first reference signal resource set; when the first time unit is a time unit in a second time unit set, the target reference signal resource set is the second reference signal resource set; the first time unit set corresponds to a first sub-band, and the second time unit set corresponds to a second sub-band, the first sub-band and the second sub-band both belong to a same BWP (bandwidth part), and the first sub-band and the second sub-band are different.

In one subembodiment of the above embodiment, the first node monitors a CORESET (Control Resource Set) on a first sub-band in the first time unit set, and the first node monitors a CORESET on a second sub-band in the second time unit set.

In one embodiment, the first information block is transmitted through an RRC signaling.

In one embodiment, a name of an RRC signaling used to transmit the first information block comprises Slot.

In one embodiment, a name of an RRC signaling used to transmit the first information block comprises SlotFormat.

In one embodiment, a name of an RRC signaling used to transmit the first information block comprises Format.

In one embodiment, the first information block is transmitted through a MAC CE.

In one embodiment, a name of a MAC CE used for transmitting the first information block comprises Slot.

In one embodiment, a name of a MAC CE used for transmitting the first information block comprises SlotFormat.

In one embodiment, a name of a MAC CE used for transmitting the first information block comprises Format.

In one embodiment, the first information block is transmitted through DCI.

In one embodiment, when the first information block is transmitted through DCI, a format adopted by DCI is DCI Format 2_0

In one embodiment, the meaning of the above phrase that a format adopted by a symbol comprised in the time-domain resources occupied by the first time-frequency resource set comprises: a format adopted for a slot where the first time-frequency resource set is located.

In one embodiment, the meaning of the above phrase that a format adopted by a symbol comprised in the time-domain resources occupied by the first time-frequency resource set comprises: a format adopted by all symbols occupied by the first time-frequency resource set.

In one embodiment, a format adopted by symbols comprised in the time-domain resources occupied by the first time-frequency resource set is one of “D”, “U” or “F”.

In one embodiment, the second information block is transmitted through an RRC signaling.

In one embodiment, a name of an RRC signaling used to transmit the second information block comprises TCI.

In one embodiment, a name of an RRC signaling used to transmit the second information block comprises State.

In one embodiment, a name of an RRC signaling used to transmit the second information block comprises SRI.

In one embodiment, a name of an RRC signaling used to transmit the second information block comprises Slot.

In one embodiment, a name of an RRC signaling used to transmit the second information block comprises SlotFormat.

In one embodiment, a name of an RRC signaling used to transmit the second information block comprises Format.

In one embodiment, a name of an RRC signaling used to transmit the second information block comprises PDSCH.

In one embodiment, a name of an RRC signaling used to transmit the second information block comprises PUSCH.

In one embodiment, the second information block is transmitted through a MAC CE.

In one embodiment, a name of a MAC CE used for transmitting the second information block comprises TCI.

In one embodiment, a name of a MAC CE used for transmitting the second information block comprises SRI.

In one embodiment, a name of a MAC CE used for transmitting the second information block comprises Slot.

In one embodiment, a name of a MAC CE used for transmitting the second information block comprises SlotFormat.

In one embodiment, a name of a MAC CE used for transmitting the second information block comprises Format.

In one embodiment, M1 is equal to 2, and the M1 reference signal resource sets respectively correspond to the first reference signal resource set and a second reference signal resource set in the present application.

In one embodiment, M1 is equal to 3, and the M1 reference signal resource sets respectively correspond to a first candidate reference signal resource set, a second candidate reference signal resource set, and a third candidate reference signal resource set; when a format of symbols occupied by the first time-frequency resource set is “D”, the target reference signal resource set is the first candidate reference signal resource set; when a format of symbols occupied by the first time-frequency resource set is “U”, the target reference signal resource set is the second candidate reference signal resource set; when a format of symbols occupied by the first time-frequency resource set is “F”, the target reference signal resource set is the third candidate reference signal resource set.

### Embodiment 5B

Embodiment 5B illustrates a flowchart of a first signaling, as shown in FIG. 5B. In FIG. 5B, a first node U1B and a second node N2B are in communications via a radio link. It is particularly underlined that the order illustrated in the embodiment does not put constraints over sequences of signal transmissions and implementations. Embodiments, sub-embodiments and subsidiary embodiments of embodiments 5B can be applied to embodiment 6B without conflict; on the contrary, embodiments, sub-embodiments and subsidiary embodiments of embodiments 6B can be applied to embodiment 5B without conflict.

The first node U1B receives a second information block in step S10B; receives a first information block in step S11B; receives a first signaling in step S12B; in step 13B, receives a first signal in a first time-frequency resource set.

The second node N2B transmits a second information block in step S20B; transmits a first information block in step S21B; transmits a first signaling in step S22B; transmits a first signal in a first time-frequency resource set in step S23B.

In embodiment 5B, the first information block comprises configuration information of a target sub-band, configuration information of the target sub-band is used to at least determine a slot format for the target sub-band, and the first signaling is used to determine a first time-frequency resource set and a first reference signal resource; the first reference signal resource is used to determine spatial parameters of the first signal; the first time-frequency resource set comprises at least one resource block in frequency domain and at least one symbol in time domain; the first reference signal resource is one of K1 candidate reference signal resources, K1 is a positive integer greater than 1, and the first signaling indicates the first reference signal resource from the K1 candidate reference signal resources; a target reference signal resource set comprises K1 candidate reference signal resources, and the target reference signal resource set is one of M1 reference signal resource sets, where M1 is a positive integer greater than 1; at least one of a relation between the first time-frequency resource set and the target sub-band, or configuration information of the target sub-band is used to determine the target reference signal resource set from the M1 reference signal resource sets; frequency-domain resources occupied by the first time-frequency resource set and the target sub-band belong to a same BWP; the second information block is used to indicate the M1 reference signal resource sets.

In one embodiment, a first boundary frequency is equal to a lowest boundary frequency of the target sub-band, and a second boundary frequency is equal to a highest boundary frequency of the target sub-band; a first reference frequency is equal to a difference value in an interval length between the first boundary frequency and a target frequency, and a second reference frequency is equal to a sum of an interval length between a second boundary frequency and the target frequency; a first frequency interval is a frequency interval between the first boundary frequency and the first reference frequency, and a second frequency interval is a frequency interval from the second reference frequency to the second boundary frequency; a location relation between the first time-frequency resource set in frequency domain and the first frequency interval, or a location relation between the second frequency intervals, is used to determine the target reference signal resource set from the M1 reference signal resource sets.

In one embodiment, configuration information of the target sub-band comprises at least one of location information of the target sub-band in frequency domain or a link direction indication of the target sub-band; when configuration information of the target sub-band comprises a link direction indication of the target sub-band, a link direction indication of the target sub-band is used to determine a slot format for the target sub-band.

In one embodiment, the M1 reference signal resource sets comprise a first reference signal resource set and a second reference signal resource set; when there exists an overlapping between the first time-frequency resource set and the first frequency interval or the second frequency interval in frequency domain, and a link direction of the target sub-band is flexible or variable, the target reference signal resource set is the first reference signal resource set; when there does not exist an overlapping between the first time-frequency resource set and any of the first frequency interval or the second frequency interval in frequency domain, the target reference signal resource set is the second reference signal resource set.

In one subembodiment of the embodiment, the first reference signal resource set comprises N1 reference signal resources, N1 being a positive integer greater than one.

In one subsidiary embodiment of the subembodiment, the N1 is equal to 8.

In one subsidiary embodiment of the subembodiment, the N1 reference signal resources respectively correspond to N1 TCIs.

In one subsidiary embodiment of the subembodiment, the N1 reference signal resources respectively correspond to N1 TCI-States.

In one subsidiary embodiment of the subembodiment, the N1 reference signal resources respectively correspond to N1 TCI-StateIds.

In one subembodiment of the embodiment, the second reference signal resource set comprises N2 reference signal resources, N2 being a positive integer greater than one.

In one subsidiary embodiment of the subembodiment, N2 is equal to 8.

In one subsidiary embodiment of the subembodiment, the N2 reference signal resources respectively correspond to N2 TCIs.

In one subsidiary embodiment of the subembodiment, the N2 reference signal resources respectively correspond to N2 TCI-States.

In one subsidiary embodiment of the subembodiment, the N2 reference signal resources respectively correspond to N2 TCI-StateIds.

In one subembodiment of the above embodiment, the meaning that the there exists an overlapping between the first time-frequency resource set and the first frequency interval in frequency domain comprises: there at least exists one subcarrier belonging to the first time-frequency resource set and the first frequency interval at the same time.

In one subembodiment of the above embodiment, the meaning that the there exists an overlapping between the first time-frequency resource set and the first frequency interval in frequency domain comprises: there at least exists one PRB belonging to the first time-frequency resource set and the first frequency interval at the same time.

In one subembodiment of the above embodiment, the meaning that the there exists an overlapping between the first time-frequency resource set and the second frequency interval in frequency domain comprises: there at least exists one subcarrier belonging to the first time-frequency resource set and the second frequency interval at the same time.

In one subembodiment of the above embodiment, the meaning that the there exists an overlapping between the first time-frequency resource set and the second frequency interval in frequency domain comprises: there at least exists one PRB belonging to the first time-frequency resource set and the second frequency interval at the same time.

In one subembodiment of the above embodiment, the meaning that there does not exist an overlapping between the first time-frequency resource set and any frequency interval in the first frequency interval or the second frequency interval in frequency domain comprises: there does not exist a subcarrier belonging to the first time-frequency resource set and the first frequency interval at the same time, and there does not exist a subcarrier belonging to the first time-frequency resource set and the second frequency interval at the same time.

In one subembodiment of the above embodiment, the meaning that there does not exist an overlapping between the first time-frequency resource set and any frequency interval in the first frequency interval or the second frequency interval in frequency domain comprises: there does not exist a PRB belonging to the first time-frequency resource set and the first frequency interval at the same time, and there does not exist a PRB belonging to the first time-frequency resource set and the second frequency interval at the same time.

In one subembodiment of the above embodiment, the meaning that the there exists an overlapping between the first time-frequency resource set and the first frequency interval in frequency domain comprises: there at least exists one subcarrier belonging to the first time-frequency resource set and the first frequency interval at the same time.

In one subembodiment of the above embodiment, the meaning that the there exists an overlapping between the first time-frequency resource set and the first frequency interval in frequency domain comprises: there at least exists one PRB belonging to the first time-frequency resource set and the first frequency interval at the same time.

In one subembodiment of the above embodiment, the meaning that the there exists an overlapping between the first time-frequency resource set and the second frequency interval in frequency domain comprises: there at least exists one subcarrier belonging to the first time-frequency resource set and the second frequency interval at the same time.

In one subembodiment of the above embodiment, the meaning that the there exists an overlapping between the first time-frequency resource set and the second frequency interval in frequency domain comprises: there at least exists one PRB belonging to the first time-frequency resource set and the second frequency interval at the same time.

In one subembodiment of the above embodiment, the meaning that there does not exist an overlapping between the first time-frequency resource set and any frequency interval in the first frequency interval or the second frequency interval in frequency domain comprises: there does not exist a subcarrier belonging to the first time-frequency resource set and the first frequency interval at the same time, and there does not exist a subcarrier belonging to the first time-frequency resource set and the second frequency interval at the same time.

In one subembodiment of the above embodiment, the meaning that there does not exist an overlapping between the first time-frequency resource set and any frequency interval in the first frequency interval or the second frequency interval in frequency domain comprises: there does not exist a PRB belonging to the first time-frequency resource set and the first frequency interval at the same time, and there does not exist a PRB belonging to the first time-frequency resource set and the second frequency interval at the same time.

In one embodiment, the second information block is transmitted through an RRC signaling.

In one embodiment, a name of an RRC signaling used to transmit the second information block comprises TCI.

In one embodiment, a name of an RRC signaling used to transmit the second information block comprises State.

In one embodiment, a name of an RRC signaling used to transmit the second information block comprises SRI.

In one embodiment, a name of an RRC signaling used to transmit the second information block comprises Slot.

In one embodiment, a name of an RRC signaling used to transmit the second information block comprises SlotFormat.

In one embodiment, a name of an RRC signaling used to transmit the second information block comprises Format.

In one embodiment, a name of an RRC signaling used to transmit the second information block comprises PDSCH.

In one embodiment, a name of an RRC signaling used to transmit the second information block comprises PUSCH.

In one embodiment, the second information block is transmitted through a MAC CE.

In one embodiment, a name of a MAC CE used for transmitting the second information block comprises TCI.

In one embodiment, a name of a MAC CE used for transmitting the second information block comprises SRI.

In one embodiment, a name of a MAC CE used for transmitting the second information block comprises Slot.

In one embodiment, a name of a MAC CE used for transmitting the second information block comprises SlotFormat.

In one embodiment, a name of a MAC CE used for transmitting the second information block comprises Format.

In one embodiment, M1 is equal to 2, and the M1 reference signal resource sets respectively correspond to the first reference signal resource set and the second reference signal resource set in the present application.

In one embodiment, M1 is equal to 4, and the M1 reference signal resource sets comprise the first reference signal resource set, the second reference signal resource set, the third reference signal resource set, and the fourth reference signal resource set in the present application.

In one embodiment, the first information block is before the second information block.

In one embodiment, the first information block is after the second information block.

In one embodiment, the first information block and the second information block are different.

In one embodiment, the first information block and the second information block are transmitted through two different physical channels.

In one embodiment, the first information block and the second information block are transmitted through a same physical channel.

In one embodiment, the first information block and the second information block are two different fields or two different IEs comprised in a same signaling.

In one embodiment, frequency-domain resources occupied by the first time-frequency resource set and the target sub-band belong to a first BWP, and the M1 reference signal resource sets are associated with the first BWP.

In one embodiment, frequency-domain resources occupied by the first time-frequency resource set and the target sub-band belong to a first BWP, and the M1 reference signal resource sets are configured to the first BWP.

In one embodiment, the first information block is transmitted through an RRC signaling.

In one embodiment, a name of an RRC signaling used to transmit the first information block comprises Slot.

In one embodiment, a name of an RRC signaling used to transmit the first information block comprises SlotFormat.

In one embodiment, a name of an RRC signaling used to transmit the first information block comprises Format.

In one embodiment, the first information block is transmitted through a MAC CE.

In one embodiment, a name of a MAC CE used for transmitting the first information block comprises Slot.

In one embodiment, a name of a MAC CE used for transmitting the first information block comprises SlotFormat.

In one embodiment, a name of a MAC CE used for transmitting the first information block comprises Format.

In one embodiment, the first information block is transmitted through DCI.

In one embodiment, when the first information block is transmitted through DCI, a format adopted by DCI is DCI Format 2_0.

In one embodiment, the meaning of the above phrase that a format adopted by a symbol comprised in the time-domain resources occupied by the first time-frequency resource set comprises: a format adopted for a slot where the first time-frequency resource set is located.

In one embodiment, the meaning of the above phrase that a format adopted by a symbol comprised in the time-domain resources occupied by the first time-frequency resource set comprises: a format adopted by all symbols occupied by the first time-frequency resource set.

In one embodiment, a format adopted by symbols comprised in the time-domain resources occupied by the first time-frequency resource set is one of “D”, “U” or “F”.

### Embodiment 6A

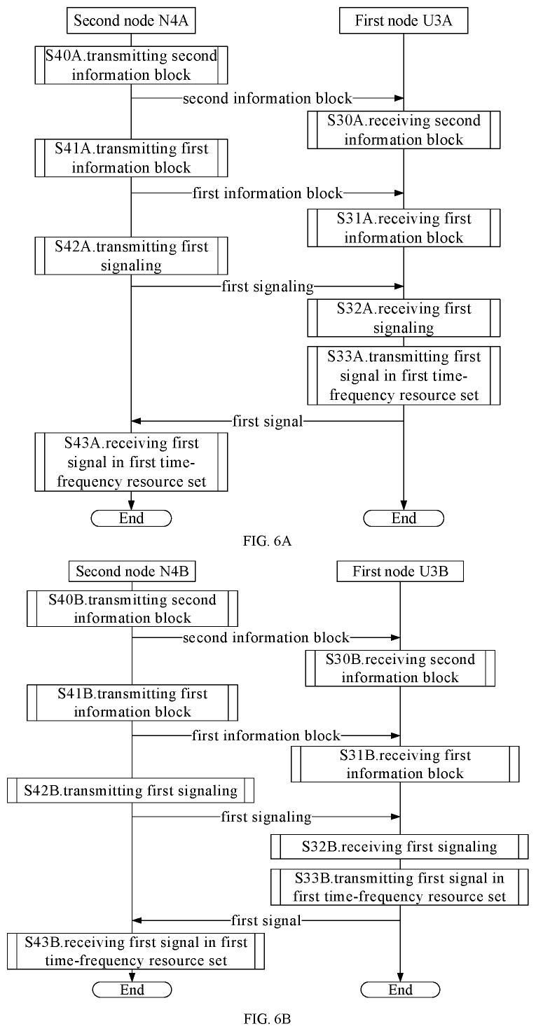

Embodiment 6 illustrates another flowchart of a first signaling, as shown in FIG. 6. In FIG. 6A, a first node U3A and a second node N4A are in communications via a radio link. It is particularly underlined that the order illustrated in the embodiment does not put constraints over sequences of signal transmissions and implementations. Embodiments, sub-embodiments and subsidiary embodiments of embodiment 6A can be applied to embodiment 5A if no conflict is caused; on the contrary, embodiments, sub-embodiments and subsidiary embodiments of embodiments 5A can be applied to embodiment 6A without conflict.

The first node U3A receives a second information block in step S30A; receives a first information block in step S31A; receives a first signaling in step S32A; transmits a first signal in a first time-frequency resource set in step S33A.

The second node N4A transmits a second information block in step S40A; transmits a first information block in step S41A; transmits a first signaling in step S42A; in step 43A, receives a first signal in a first time-frequency resource set.

In embodiment 6A, the first reference signal resource is used to determine spatial parameters of the first signal; the first signaling is used to indicate the first time-frequency resource set; the first reference signal resource is one of K1 candidate reference signal resources, K1 is a positive integer greater than 1, and the first signaling indicates the first reference signal resource from the K1 candidate reference signal resources; a target reference signal resource set comprises K1 candidate reference signal resources, and the target reference signal resource set is one of M1 reference signal resource sets, where M1 is a positive integer greater than 1; time-domain resources occupied by the first time-frequency resource set are used to determine the target reference signal resource set from the M1 reference signal resource sets; the first information block is used to indicate a format adopted by a symbol comprised in the time-domain resources occupied by the first time-frequency resource set; the second information block is used to indicate the M1 reference signal resource sets.

In one embodiment, the M1 reference signal resource sets comprise a first reference signal resource set and a second reference signal resource set, and time-domain resources occupied by the first time-frequency resource set comprise a first symbol set; when a format adopted by a symbol in the first symbol set is a first format, the target reference signal resource set is the first reference signal resource set; when a format adopted by a symbol in the first symbol set is a second format, the target reference signal resource set is the second reference signal resource set; the first format and the second format are different.

In one subembodiment of the above embodiment, the first format is “U”, and the second format is “F”.

In one embodiment, the M1 reference signal resource sets comprise a first reference signal resource set and a second reference signal resource set, and time-domain resources occupied by the first time-frequency resource set belongs to a first time unit; when the first time unit is a time unit in a first time unit set, the target reference signal resource set is the first reference signal resource set; when the first time unit is a time unit in a second time unit set, the target reference signal resource set is the second reference signal resource set; a format of any time unit in the first time unit set is different from a format of any time unit in the second time unit set.

In one subembodiment of the embodiment, a format of any time unit in the first time unit set is “U”, and a format of any time unit in the second time unit set is “F”.

In one embodiment, a format adopted by symbols comprised in the time-domain resources occupied by the first time-frequency resource set is one of “D”, “U” or “F”.

In one embodiment, M1 is equal to 3, and the M1 reference signal resource sets respectively correspond to a first candidate reference signal resource set, a second candidate reference signal resource set, and a third candidate reference signal resource set; when a format of symbols occupied by the first time-frequency resource set is “D”, the target reference signal resource set is the first candidate reference signal resource set; when a format of symbols occupied by the first time-frequency resource set is “U”, the target reference signal resource set is the second candidate reference signal resource set; when a format of symbols occupied by the first time-frequency resource set is “F”, the target reference signal resource set is the third candidate reference signal resource set.

In one embodiment, transmit power of the first signal is equal to a first power value, the first power value is not greater than a first threshold, the first threshold is one of M2 candidate thresholds, time-domain resources occupied by the first time-frequency resource set are used to determine the first threshold from the M2 candidate thresholds; M2 is a positive integer greater than 1.

In one subembodiment of the above embodiment, the M2 is equal to the M1.

In one subembodiment of the above embodiment, the first power value is measure by dBm.

In one subembodiment of the above embodiment, the first power value is measure by milliwatts.

In one subembodiment of the embodiment, the first threshold is measured by dBm.

In one subembodiment of the above embodiment, the first threshold is measured by milliwatts.

In one subembodiment of the embodiment, the first threshold is P_{CMAX,f,c}.

In one subembodiment of the embodiment, the first threshold is used to determine P_{CMAX,f,c}.

In one subembodiment of the embodiment, the first threshold is P_{CMAX_H,f,c}.

In one subembodiment of the embodiment, M2 is equal to 2, and the M2 candidate thresholds are respectively a first candidate threshold and a second candidate threshold; when the target reference signal resource set is the first reference signal resource set, the first threshold is the first candidate threshold; when the target reference signal resource set is the second reference signal resource set, the first threshold is the second candidate threshold.

In one subembodiment of the embodiment, M2 is equal to 3, and the M2 candidate thresholds are respectively a first candidate threshold, a second candidate threshold and a third candidate threshold; when a format of symbols occupied by the first time-frequency resource set is “D”, the first threshold is the first candidate threshold; when a format of symbols occupied by the first time-frequency resource set is “U”, the first threshold is the second candidate threshold; when a format of symbols occupied by the first time-frequency resource set is “F”, the first threshold is the third candidate threshold.

In one embodiment, transmit power of the first signal is equal to a first power value, the first power value is linearly correlated with a target power value, the target power value is equal to one of M3 candidate power values, and time-domain resources occupied by the first time-frequency resource set are used to determine the target power value from the M3 candidate power values, M3 is a positive integer greater than 1.

In one subembodiment of the above embodiment, the M3 is equal to the M1.

In one subembodiment of the embodiment, the target power is measured by dBm.

In one subembodiment of the above embodiment, the target power value is measure by milliwatts.

In one subembodiment of the embodiment, the target power is measured by dB.

In one subembodiment of the embodiment, M3 is equal to 2, and the M3 candidate power values are respectively the first candidate power value and the second candidate power value; when the target reference signal resource set is the first reference signal resource set, the target power value is the first candidate power value; when the target reference signal resource set is the second reference signal resource set, the target power value is the second candidate power value.

In one subembodiment of the embodiment, M3 is equal to 3, and the M3 candidate power values are respectively a first candidate power value, a second candidate power value, and a third candidate power value; when a format of symbols occupied by the first time-frequency resource set is “D”, the target power value is the first candidate power value; when a format of symbols occupied by the first time-frequency resource set is “U”, the target power value is the second candidate power value; when a format of symbols occupied by the first time-frequency resource set is “F”, the target power value is the third candidate power value.

In one subembodiment of the embodiment, the target power value is P_{O_PUSCH,b,f,c}(j).

In one subembodiment of the embodiment, the target power value is Δ_{TF,b,f,c}(i).

In one subembodiment of the embodiment, the target power value is f_{b,f,c}(i,l).

In one subembodiment of the embodiment, the target power value is α_{b,f,c}(j)·PL_{b,f,c}(q_{d}), a value of α_{b,f,c}(j) is related to time-domain resources occupied by the first time-frequency resource set, and PL_{b,f,c}(q_{d}) is pathloss between the first node and the second node.

In one subsidiary embodiment of the subembodiment, when a format of symbols occupied by the first time-frequency resource set is “D”, a value of the α_{b,f,c}(j) is equal to a first coefficient; when a format of symbols occupied by the first time-frequency resource set is “U”, a value of the α_{b,f,c}(j) is equal to a second coefficient; when a format of symbols occupied by the first time-frequency resource set is “F”, a value of the α_{b,f,c}(j) is equal to a third coefficient; the first coefficient, a second coefficient, and a third coefficient are all different and are positive real numbers less than 1.

In one subsidiary embodiment of the subembodiment, when the target reference signal resource set is the first reference signal resource set, a value of the α_{b,f,c}(j) is equal to a first coefficient; when the target reference signal resource set is the second reference signal resource set, a value of the α_{b,f,c}(j) is equal to a second coefficient; the first coefficient and the second coefficient are not the same, and both are positive real numbers less than 1.

### Embodiment 6B

Embodiment 6B illustrates another flowchart of a first signaling, as shown in FIG. 6B. In FIG. 6B, a first node U3B and a second node N4B are in communications via a radio link. It is particularly underlined that the order illustrated in the embodiment does not put constraints over sequences of signal transmissions and implementations. Embodiments, sub-embodiments and subsidiary embodiments of embodiment 6B can be applied to embodiment 5B if no conflict is caused; on the contrary, embodiments, sub-embodiments and subsidiary embodiments of embodiments 5B can be applied to embodiment 6B without conflict.

The first node U3B receives a second information block in step S30B; receives a first information block in step S31B; receives a first signaling in step S32B; transmits a first signal in a first time-frequency resource set in step S33B.

The second node N4B transmits a second information block in step S40B; transmits a first information block in step S41B; transmits a first signaling in step S42B; in step 43B, receives a first signal in a first time-frequency resource set.

In embodiment 6B, the first information block comprises configuration information of a target sub-band, configuration information of the target sub-band is used to at least determine a slot format for the target sub-band, and the first signaling is used to determine a first time-frequency resource set and a first reference signal resource; the first reference signal resource is used to determine spatial parameters of the first signal; the first time-frequency resource set comprises at least one resource block in frequency domain and at least one symbol in time domain; the first reference signal resource is one of K1 candidate reference signal resources, K1 is a positive integer greater than 1, and the first signaling indicates the first reference signal resource from the K1 candidate reference signal resources; a target reference signal resource set comprises K1 candidate reference signal resources, and the target reference signal resource set is one of M1 reference signal resource sets, where M1 is a positive integer greater than 1; at least one of a relation between the first time-frequency resource set and the target sub-band, or configuration information of the target sub-band is used to determine the target reference signal resource set from the M1 reference signal resource sets; frequency-domain resources occupied by the first time-frequency resource set and the target sub-band belong to a same BWP; the second information block is used to indicate the M1 reference signal resource sets.

In one embodiment, a first boundary frequency is equal to a lowest boundary frequency of the target sub-band, and a second boundary frequency is equal to a highest boundary frequency of the target sub-band; a first reference frequency is equal to a difference value in an interval length between the first boundary frequency and a target frequency, and a second reference frequency is equal to a sum of an interval length between a second boundary frequency and the target frequency; a first frequency interval is a frequency interval between the first boundary frequency and the first reference frequency, and a second frequency interval is a frequency interval from the second reference frequency to the second boundary frequency; a location relation between the first time-frequency resource set in frequency domain and the first frequency interval, or a location relation between the second frequency intervals, is used to determine the target reference signal resource set from the M1 reference signal resource sets.

In one embodiment, configuration information of the target sub-band comprises at least one of location information of the target sub-band in frequency domain or a link direction indication of the target sub-band; when configuration information of the target sub-band comprises a link direction indication of the target sub-band, a link direction indication of the target sub-band is used to determine a slot format for the target sub-band.

In one embodiment, transmit power of the first signal is equal to a first power value, the first power value is not greater than a first threshold, the first threshold is one of M2 candidate thresholds, and at least one of a relation between the first time-frequency resource set and the target sub-band or configuration information of the target sub-band is used to determine the first threshold from the M2 candidate thresholds; M2 is a positive integer greater than 1.

In one embodiment, the M1 reference signal resource sets comprise a third reference signal resource set and a fourth reference signal resource set; when there exists an overlapping between the first time-frequency resource set and the first frequency interval or the second frequency interval in frequency domain, and a link direction of the target sub-band is flexible or variable, the target reference signal resource set is the third reference signal resource set; when there does not exist an overlapping between the first time-frequency resource set and any of the first frequency interval or the second frequency interval in frequency domain, the target reference signal resource set is the fourth reference signal resource set.

In one subembodiment of the embodiment, the third reference signal resource set comprises N3 reference signal resources, N3 being a positive integer greater than one.

In one subsidiary embodiment of the subembodiment, the N3 is equal to 3.

In one subsidiary embodiment of the subembodiment, the N3 reference signal resources respectively correspond to N3 SRIs.

In one subsidiary embodiment of the subembodiment, the N3 reference signal resources respectively correspond to N1 SRI-States.

In one subsidiary embodiment of the subembodiment, the N3 reference signal resources respectively correspond to N1 SRI-StateIds.

In one subembodiment of the embodiment, the fourth reference signal resource set comprises N4 reference signal resources, N4 being a positive integer greater than one.

In one subsidiary embodiment of the subembodiment, N4 is equal to 8.

In one subsidiary embodiment of the subembodiment, the N4 reference signal resources respectively correspond to N4 SRIs.

In one subsidiary embodiment of the subembodiment, the N4 reference signal resources respectively correspond to N1 SRI-States.

In one subsidiary embodiment of the subembodiment, the N4 reference signal resources respectively correspond to N1 SRI-StateIds.

In one subembodiment of the above embodiment, the meaning that the there exists an overlapping between the first time-frequency resource set and the first frequency interval in frequency domain comprises: there at least exists one subcarrier belonging to the first time-frequency resource set and the first frequency interval at the same time.

In one subembodiment of the above embodiment, the meaning that the there exists an overlapping between the first time-frequency resource set and the first frequency interval in frequency domain comprises: there at least exists one PRB belonging to the first time-frequency resource set and the first frequency interval at the same time.

In one subembodiment of the above embodiment, the meaning that the there exists an overlapping between the first time-frequency resource set and the second frequency interval in frequency domain comprises: there at least exists one subcarrier belonging to the first time-frequency resource set and the second frequency interval at the same time.

In one subembodiment of the above embodiment, the meaning that the there exists an overlapping between the first time-frequency resource set and the second frequency interval in frequency domain comprises: there at least exists one PRB belonging to the first time-frequency resource set and the second frequency interval at the same time.

In one subembodiment of the above embodiment, the meaning that there does not exist an overlapping between the first time-frequency resource set and any frequency interval in the first frequency interval or the second frequency interval in frequency domain comprises: there does not exist a subcarrier belonging to the first time-frequency resource set and the first frequency interval at the same time, and there does not exist a subcarrier belonging to the first time-frequency resource set and the second frequency interval at the same time.

In one subembodiment of the above embodiment, the meaning that there does not exist an overlapping between the first time-frequency resource set and any frequency interval in the first frequency interval or the second frequency interval in frequency domain comprises: there does not exist a PRB belonging to the first time-frequency resource set and the first frequency interval at the same time, and there does not exist a PRB belonging to the first time-frequency resource set and the second frequency interval at the same time.

### Embodiment 7A

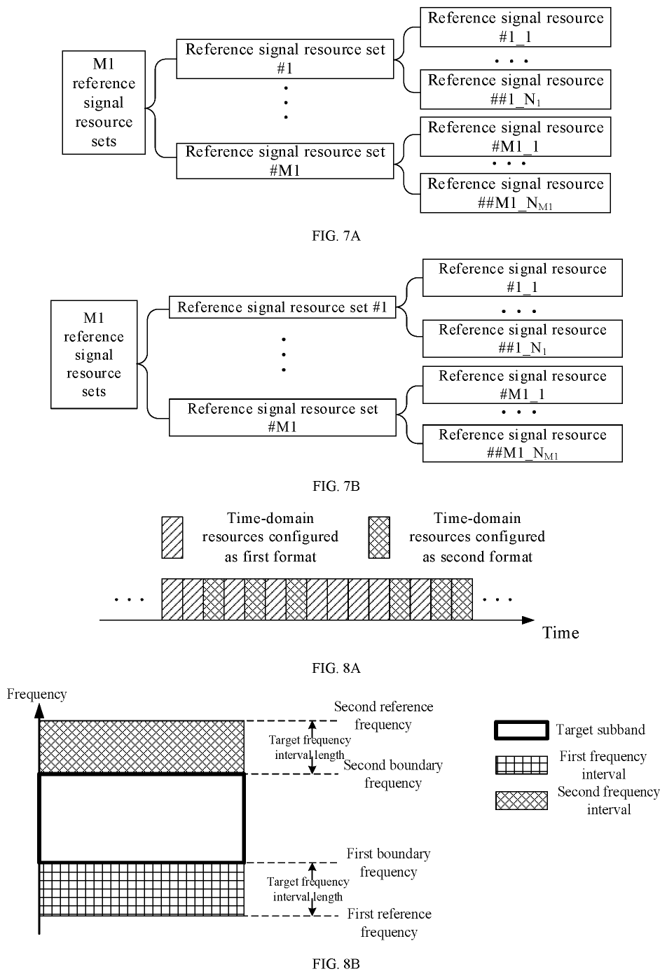

Embodiment 7A illustrates a schematic diagram of M1 reference signal resource sets, as shown in FIG. 7A. In FIG. 7A, the M1 reference signal resource sets comprise reference signal resource set #1 to reference signal resource set #M1 in the figure; the reference signal resource set #1 shown in the figure comprises reference signal resource #1_1 to reference Signal Resource #1_N₁, N₁ is a positive integer greater than 1; the reference signal resource set #M1 shown in the figure comprises reference signal resource #M1_1 to reference Signal Resource #M1_N_{M1}, N_{M1} is a positive integer greater than 1.

In one embodiment, when the first node receives the first signal, reference signal resources comprised in any reference signal resource set in the M1 reference signal resource sets correspond to a TCI-State.

In one embodiment, when the first node receives the first signal, reference signal resources comprised in any reference signal resource set in the M1 reference signal resource sets correspond to a receiving beamforming vector.

In one embodiment, when the first node transmits the first signal, reference signal resources comprised in any reference signal resource set in the M1 reference signal resource sets correspond to an SRI.

In one embodiment, when the first node transmits the first signal, reference signal resources comprised in any reference signal resource set in the M1 reference signal resource sets correspond to a transmitting beamforming vector.

### Embodiment 7B

Embodiment 7B illustrates a schematic diagram of M1 reference signal resource sets, as shown in FIG. 7B. In FIG. 7B, the M1 reference signal resource sets comprise reference signal resource set #1 to reference signal resource set #M1 in the figure; the reference signal resource set #1 shown in the figure comprises reference signal resource #1_1 to reference signal resource #1_N₁, N₁ is a positive integer greater than 1; the reference signal resource set #M1 shown in the figure comprises reference signal resource #M1_1 to reference Signal Resource #M1_N_{M1}, N_{M1} is a positive integer greater than 1.

In one embodiment, when the first node receives the first signal, reference signal resources comprised in any reference signal resource set in the M1 reference signal resource sets correspond to a TCI-State.

In one embodiment, when the first node receives the first signal, reference signal resources comprised in any reference signal resource set in the M1 reference signal resource sets correspond to a receiving beamforming vector.

In one embodiment, when the first node receives the first signal, there at least exists one reference signal resource set in the M1 reference signal resource sets corresponding to a TCI-State.

In one embodiment, when the first node receives the first signal, there exists at least one reference signal resource set in the M1 reference signal resource sets corresponding to a receiving beamforming vector.

In one embodiment, when the first node transmits the first signal, reference signal resources comprised in any reference signal resource set in the M1 reference signal resource sets correspond to an SRI.

In one embodiment, when the first node transmits the first signal, reference signal resources comprised in any reference signal resource set in the M1 reference signal resource sets correspond to a transmitting beamforming vector.

In one embodiment, when the first node transmits the first signal, there at least exists reference signal resources comprised in a reference signal resource set in the M1 reference signal resource sets corresponding to an SRI.

In one embodiment, when the first node transmits the first signal, there at least exists reference signal resources comprised in one reference signal resource set in the M1 reference signal resource sets corresponding to a transmitting beamforming vector.

### Embodiment 8A

Embodiment 8A illustrates a schematic diagram of time-domain resources occupied by a first time-frequency resource set, as shown in FIG. 8A. In FIG. 8A, the slash-filled rectangle in the figure represents time-domain resources being configured as a first format; the cross line-filled rectangle in the figure represents time-domain resources being configured as a second format; when time-domain resources occupied by the first time-frequency resource set belong to time-domain resources configured as the first format, the target reference signal resource set is a first reference signal resource set; when time-domain resources occupied by the first time-frequency resource set belong to time-domain resources configured as the second format, the target reference signal resource set is a second reference signal resource set.

In one embodiment, when the first node receives the first signal, the first format is “D” and the second format is “F”.

In one embodiment, when the first node transmits the first signal, the first format is “U” and the second format is “F”.

In one embodiment, the rectangle shown in the figure represents a symbol.

In one embodiment, the rectangle shown in the figure represents a slot.

### Embodiment 8B

Embodiment 8B illustrates a schematic diagram of a first frequency interval and a second frequency interval according to one embodiment of the present application, as shown in FIG. 8B. In FIG. 8B, the vertical axis represents frequency, the unfilled rectangle in the thick wireframe represents a target sub-band, the reticle filled rectangle represents a first frequency interval, and cross line-filled rectangle represents a second frequency interval.

In embodiment 8B, a first boundary frequency is equal to a lowest boundary frequency of the target sub-band in the present application, and a second boundary frequency is equal to a highest boundary frequency of the target sub-band; a first reference frequency is equal to a difference value in an interval length between the first boundary frequency and a target frequency, and a second reference frequency is equal to a sum of an interval length between a second boundary frequency and the target frequency; a first frequency interval is a frequency interval between the first boundary frequency and the first reference frequency, and a second frequency interval is a frequency interval from the second reference frequency to the second boundary frequency; a location relation between the first time-frequency resource set in frequency domain and the first frequency interval or the second frequency interval is used to determine the target reference signal resource set from the M1 reference signal resource sets in the present application.

In one embodiment, a relation between the first time-frequency resource set and the target sub-band comprises a location relation between the first time-frequency resource set in frequency domain and the first frequency interval or the second frequency interval.

In one embodiment, the first boundary frequency is a lowest frequency point of the target sub-band.

In one embodiment, the first boundary frequency is a lowest frequency that can be comprised in the target sub-band.

In one embodiment, the second boundary frequency is a highest frequency point of the target sub-band.

In one embodiment, the second boundary frequency is a highest frequency that can be comprised in the target sub-band.

In one embodiment, a difference value between the second boundary frequency and the first boundary frequency is equal to a bandwidth of the target sub-band.

In one embodiment, a length of the target frequency interval is greater than 0.

In one embodiment, a length of the target frequency interval is equal to 4 MHz.

In one embodiment, a length of the target frequency interval is equal to 8 MHz.

In one embodiment, a length of the target frequency interval is pre-defined.

In one embodiment, a length of the target frequency interval is explicitly or implicitly configured.

In one embodiment, a location relation between the first time-frequency resource set in frequency domain and the first frequency interval or the second frequency interval comprises: whether the first time-frequency resource set comprises at least one subcarrier in frequency domain belonging to one of the first frequency interval or the second frequency interval.

In one embodiment, a location relation between the first time-frequency resource set in frequency domain and the first frequency interval or the second frequency interval comprises: whether the first time-frequency resource set is orthogonal to either the first frequency interval or the second frequency interval in frequency domain.

In one embodiment, a location relation between the first time-frequency resource set in frequency domain and the first frequency interval or the second frequency interval comprises: whether the first time-frequency resource set in frequency domain is confined within the first frequency interval or the second frequency interval.

In one embodiment, a location relation between the first time-frequency resource set in frequency domain and the first frequency interval or the second frequency interval comprises: whether the first frequency interval or the second frequency interval comprises any resource block comprised in the frequency domain in the first time-frequency resource set.

In one embodiment, a location relation between the first time-frequency resource set in frequency domain and the first frequency interval or the second frequency interval comprises: whether any resource block comprised in frequency domain in the first time-frequency resource set is comprised in the first frequency interval or the second frequency interval.

In one embodiment, a location relation between the first time-frequency resource set in frequency domain and the first frequency interval or the second frequency interval comprises: whether any frequency point comprised in frequency domain in the first time-frequency resource set belongs to the first frequency interval or the second frequency interval.

In one embodiment, the expression in the claim that a location relation between the first time-frequency resource set in frequency domain and the first frequency interval or the second frequency interval is used to determine the target reference signal resource set from the M1 reference signal resource sets comprises the following meaning: a location relation between the first time-frequency resource set in frequency domain and the first frequency interval or the second frequency interval is used by the first node in the present application to determine the target reference signal resource set from the M1 reference signal resource sets.

In one embodiment, the expression in the claim that a location relation between the first time-frequency resource set in frequency domain and the first frequency interval or the second frequency interval is used to determine the target reference signal resource set from the M1 reference signal resource sets comprises the following meaning: when the first time-frequency resource set in frequency domain is confined within the first frequency interval or the second frequency interval, configuration information of the target sub-band is used to determine the target reference signal resource set from the M1 reference signal resource sets; otherwise, the target parameter value is equal to a predefined reference signal resource set among the M1 reference signal resource sets.

In one embodiment, the expression in the claim that a location relation between the first time-frequency resource set in frequency domain and the first frequency interval or the second frequency interval is used to determine the target reference signal resource set from the M1 reference signal resource sets comprises the following meaning: when there exists an overlapping frequency-domain resources between the first time-frequency resource set in frequency domain and any of the first frequency interval or the second frequency interval, configuration information of the target sub-band is used to determine the target reference signal resource set from the M1 reference signal resource sets; otherwise, the target parameter value is equal to a predefined reference signal resource set among the M1 reference signal resource sets.

In one embodiment, the expression in the claim that a location relation between the first time-frequency resource set in frequency domain and the first frequency interval or the second frequency interval is used to determine the target reference signal resource set from the M1 reference signal resource sets comprises the following meaning: when one of the first frequency interval or second frequency interval comprises all frequency-domain resources comprised in frequency domain in the first time-frequency resource set, configuration information of the target sub-band is used to determine the target reference signal resource set from the M1 reference signal resource sets; otherwise, the target parameter value is equal to a predefined reference signal resource set among the M1 reference signal resource sets.

In one embodiment, the expression in the claim that a location relation between the first time-frequency resource set in frequency domain and the first frequency interval or the second frequency interval is used to determine the target reference signal resource set from the M1 reference signal resource sets comprises the following meaning: when the first time-frequency resource set is orthogonal to the first frequency interval or the second frequency interval in frequency domain, the target parameter value is equal to a predefined reference signal resource set among the M1 reference signal resource sets; otherwise, configuration information of the target sub-band is used to determine the target reference signal resource set from the M1 reference signal resource sets.

### Embodiment 9A

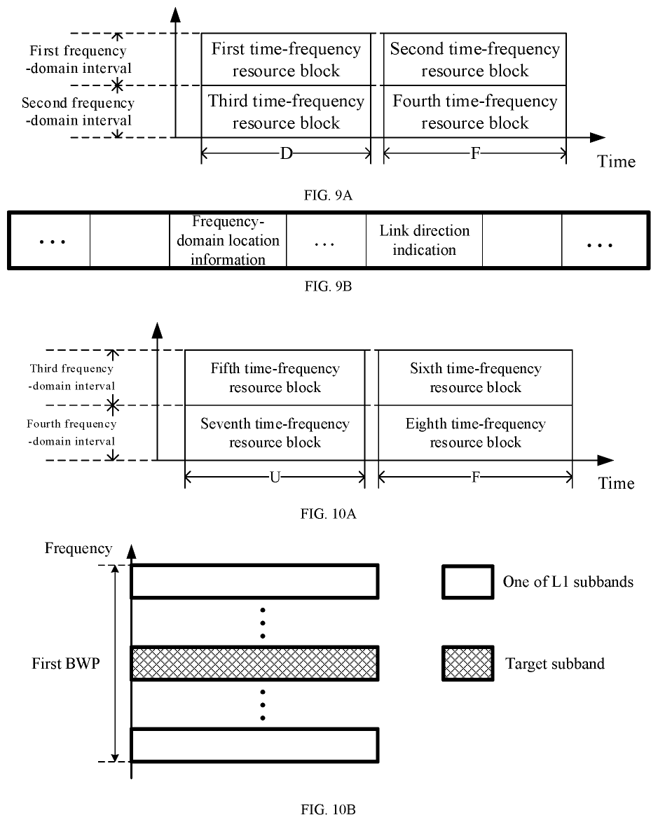

Embodiment 9A illustrates a schematic diagram of an application scenario of the present application, as shown in FIG. 9A. In FIG. 9A, a first time-frequency resource block and a second time-frequency resource block belong to a first frequency-domain interval in frequency domain, and a third time-frequency resource block and a fourth time-frequency resource block belong to a second frequency-domain interval in frequency domain; the first frequency-domain interval and the second frequency-domain interval are adjacent; the first time-frequency resource block and the third time-frequency resource block overlap in time domain, and the second time-frequency resource block and the fourth time-frequency resource block overlap in time domain; the second node in the present application schedules the first node in the first frequency-domain interval, and schedules a terminal other than the first node in the second frequency-domain interval, such as the first terminal; formats of time-domain resources occupied by the first time-frequency resource block and the third time-frequency resource block are “U”, and formats of time-domain resources occupied by the second time-frequency resource block and the fourth time-frequency resource block are “F”.

In one embodiment, when the first time-frequency resource set in the present application belongs to the first time-frequency resource block, that is, the first node is scheduled in the first time-frequency resource block, and the second node schedules the first terminal to receive downlink data in a third time-frequency resource block, then the first node and the first terminal will not interfere with each other because they receive simultaneously; furthermore, the selection of the target reference signal resource set does not need to consider interference between each other, and the target reference signal resource set is the first reference signal resource set.

In one embodiment, when the first time-frequency resource set in the present application belongs to the second time-frequency resource block, that is, the first node is scheduled in the second time-frequency resource block, and the second node schedules the first terminal to transmit uplink data in the fourth time-frequency resource block, thereby causing interference with the reception of the first node due to separate reception and transmission between the first node and the first terminal; furthermore, the selection of the target reference signal resource set avoids the uplink beamforming vector of the first terminal, and the target reference signal resource set is the second reference signal resource set.

In one embodiment, the first frequency-domain interval and the second frequency-domain interval are both a BWP.

In one embodiment, the first frequency-domain interval and the second frequency-domain interval are both a sub-band.

In one embodiment, the first frequency-domain interval and the second frequency-domain interval both occupy frequency-domain resources corresponding to a positive integer number of continuous RB(s).

### Embodiment 9B

Embodiment 9B illustrates a schematic diagram of configuration information of a target sub-band according to one embodiment of the present application, as shown in FIG. 9B.

In embodiment 9B, the configuration information of the target sub-band in the present application comprises at least one of location information of the target sub-band in frequency domain or a link direction indication of the target sub-band; a link direction indication of the target sub-band is used to determine a slot format for the target sub-band.

In one embodiment, location information of the target sub-band in frequency domain comprises an identifier or index of the target sub-band.

In one embodiment, location information of the target sub-band in frequency domain comprises an index of at least one PRB comprised in the target sub-band.

In one embodiment, location information of the target sub-band in frequency domain comprises an index of at least one subcarrier comprised in the target sub-band.

In one embodiment, location information of the target sub-band in frequency domain comprises center frequency of the target sub-band.

In one embodiment, location information of the target sub-band in frequency domain comprises frequency of a carrier to which the target sub-band belongs.

In one embodiment, location information of the target sub-band in frequency domain comprises a number of frequency band to which the target sub-band belongs.

In one embodiment, location information of the target sub-band in frequency domain comprises a frequency range (FR) to which the target sub-band belongs.

In one embodiment, location information of the target sub-band in frequency domain comprises an ID of a BWP to which the target sub-band belongs.

In one embodiment, location information of the target sub-band in frequency domain comprises whether subcarriers comprised in the target sub-band are all in the vicinity of center frequency of a carrier or a frequency band to which they belong.

In one embodiment, location information of the target sub-band in frequency domain comprises whether there exists at least one subcarrier being located near an edge of a carrier or a frequency band to which it belongs among subcarriers comprised in the target sub-band.

In one embodiment, location information of the target sub-band in frequency domain comprises whether the target sub-band is confined within a predefined range of a boundary of a frequency band to which it belongs.

In one embodiment, location information of the target sub-band in frequency domain comprises whether the target sub-band comprises a frequency point lying within a predefined range of a boundary of a frequency band to which it belongs.

In one embodiment, a link direction indication of the target sub-band is equal to a value of a field comprised in the first information block.

In one embodiment, a link direction indication of the target sub-band is equal to a value of an IE comprised in the first information block.

In one embodiment, a link direction indication of the target sub-band is equal to a value of a Boolean parameter.

In one embodiment, a link direction indication of the target sub-band is equal to a value of a Flag parameter.

In one embodiment, a link direction indication of the target sub-band is a state of a switch.

In one embodiment, a link direction of the target sub-band indicates a value equal to partial bits in a field comprised in the first information block.

In one embodiment, the expression in the claim that “configuration information of the target sub-band comprises at least one of location information of the target sub-band in frequency domain or a link direction indication of the target sub-band” comprises the following meaning: configuration information of the target sub-band comprises location information of the target sub-band in frequency domain and a link direction indication of the target sub-band.

In one embodiment, the expression in the claim that “configuration information of the target sub-band comprises at least one of location information of the target sub-band in frequency domain or a link direction indication of the target sub-band” comprises the following meaning: configuration information of the target sub-band comprises only location information of the target sub-band in frequency domain in location information of the target sub-band in frequency domain or a link direction indication of the target sub-band.

In one embodiment, the expression in the claim that “configuration information of the target sub-band comprises at least one of location information of the target sub-band in frequency domain or a link direction indication of the target sub-band” comprises the following meaning: configuration information of the target sub-band comprises only a link direction indication of the target sub-band in location information of the target sub-band in frequency domain, or a link direction indication of the target sub-band.

In one embodiment, the expression in the claim that a link direction indication of the target sub-band is used to determine a slot format for the target sub-band comprises the following meaning: a link direction indication of the target sub-band is used to explicitly or implicitly indicate whether the target sub-band is a sub-band with flexible or variable link direction.

In one embodiment, the expression in the claim that a link direction indication of the target sub-band is used to determine a slot format for the target sub-band comprises the following meaning: a link direction indication of the target sub-band is used to explicitly or implicitly indicate whether the target sub-band supports a link direction of a time-domain symbol configured by an IE “tdd-UL-DL-ConfigCommon” as uplink or downlink being overridden.

In one embodiment, the expression in the claim that a link direction indication of the target sub-band is used to determine a slot format for the target sub-band comprises the following meaning: a link direction indication of the target sub-band is used to explicitly or implicitly indicate whether the target sub-band supports a link direction of a time-domain symbol configured by an IE “tdd-UL-DL-ConfigDedicated” as uplink or downlink being overridden.

In one embodiment, the expression in the claim that a link direction indication of the target sub-band is used to determine a slot format for the target sub-band comprises the following meaning: a link direction indication of the target sub-band is used to explicitly or implicitly indicate whether the target sub-band belongs to supporting multiple link directions.

In one embodiment, the expression in the claim that a link direction indication of the target sub-band is used to determine a slot format for the target sub-band comprises the following meaning: when a link direction indication of the target sub-band is a predefined state, a first configuration set is used to determine a slot format for the target sub-band; otherwise, the second configuration set is used to determine a slot format for the target sub-band; the first configuration set and the second configuration set are different. In one subsidiary embodiment of the above embodiment, the first configuration set comprises at least one configuration signaling (or field or IE) or configuration parameter, and the second configuration set comprises at least one configuration signaling or configuration parameter. In one subsidiary embodiment of the above embodiment, the first configuration set comprises the second configuration set, and the first configuration set comprises a configuration signaling or configuration parameter other than the second configuration set. In one subsidiary embodiment of the above embodiment, the second configuration set comprises the first configuration set, and the second configuration set comprises a configuration signaling or configuration parameter other than the first configuration set. In one subsidiary embodiment of the above embodiment, there at least exists one configuration signaling or configuration parameter only belonging to one of the first configuration set or the second configuration set. In one subsidiary embodiment of the above embodiment, there exists at least one configuration signaling or configuration parameter belonging to the first configuration set and the second configuration at the same time.

In one embodiment, the expression in the claim that a link direction indication of the target sub-band is used to determine a slot format for the target sub-band comprises the following meaning: a link direction indication of the target sub-band is used by the first node in the present application to determine a slot format for the target sub-band.

In one embodiment, the expression in the claim that a link direction indication of the target sub-band is used to determine a slot format for the target sub-band comprises the following meaning: a link direction indication of the target sub-band is used to directly or indirectly determine a slot format for the target sub-band.

### Embodiment 10A

Embodiment 10A illustrates a schematic diagram of another application scenario of the present application, as shown in FIG. 10A. In FIG. 10A, a fifth time-frequency resource block and a sixth time-frequency resource block belong to a third frequency-domain interval in frequency domain, and a seventh time-frequency resource block and an eighth time-frequency resource block belong to a fourth frequency-domain interval in frequency domain; the third frequency-domain interval and the fourth frequency-domain interval are adjacent; the fifth time-frequency resource block and seventh time-frequency resource block overlap in time domain, and the sixth time-frequency resource block and the eighth time-frequency resource blocks overlap in time domain; the second node in the present application schedules the first node in the present application in the third frequency-domain interval, and schedules a terminal other than the first node in the fourth frequency-domain interval, such as a second terminal; formats of time-domain resources occupied by the fifth time-frequency resource block and the seventh time-frequency resource block are “U”, and formats of time-domain resources occupied by the sixth time-frequency resource block and the eighth time-frequency resource block are “F”.

In one embodiment, when the first time-frequency resource set in the present application belongs to the fifth time-frequency resource block, that is, the first node is scheduled in the fifth time-frequency resource block, and the second node schedules the first terminal to transmit uplink data in a seventh time-frequency resource block, then the first node and the first terminal will not interfere with each other due to simultaneous transmission; furthermore, the selection of the target reference signal resource set does not need to consider interference between each other, and the target reference signal resource set is the first reference signal resource set.

In one embodiment, when the first time-frequency resource set in the present application belongs to the sixth time-frequency resource block, that is, the first node is scheduled in the sixth time-frequency resource block, and the second node schedules the first terminal to receive downlink data in an eighth time-frequency resource block, then the reception of the second terminal will be interfered by the transmission from the first node because the first node and the second terminal transmit and receive separately; furthermore, the selection of the target reference signal resource set avoids a downlink beamforming vector of the second terminal, and the target reference signal resource set is the second reference signal resource set.

In one embodiment, the third frequency-domain interval and the fourth frequency-domain interval are both a BWP.

In one embodiment, the third frequency-domain interval and the fourth frequency-domain interval are both a sub-band.

In one embodiment, the third frequency-domain interval and the fourth frequency-domain interval both occupy frequency-domain resources corresponding to positive integer number of continuous RBs.

### Embodiment 10B

Embodiment 10B illustrates a schematic diagram of a target sub-band, as shown in FIG. 10B. In FIG. 10B, a first BWP comprises L1 sub-bands, where L1 is a positive integer greater than 1, and the target sub-band is one of the L1 sub-bands; any two sub-bands in the L1 sub-band are orthogonal in frequency domain; a number of RBs comprised in any of the L1 sub-bands is a positive integer greater than 1.

In one embodiment, the L1 sub-bands comprise L2 resource blocks, and the L2 is fixed or the L2 is configured through an RRC signaling.

In one embodiment, there at least exist numbers of resource blocks comprised in two sub-bands in the L1 sub-band being different.

In one embodiment, there at least exists one sub-band in L1 sub-bands only being configured to be used for downlink transmission.

In one embodiment, there at least exists one sub-band whose slot format being configured as “D” among L1 sub-bands.

In one embodiment, there at least exists one sub-band in L1 sub-bands only being configured to be used for uplink transmission.

In one embodiment, there at least exists one sub-band whose slot format being configured as “U” among L1 sub-bands.

In one embodiment, there at least exists one sub-band being configured as variable duplex link direction among L1 sub-bands.

In one embodiment, there at least exists one sub-band being configured as flexible link direction among L1 sub-bands.

In one embodiment, there at least exists one sub-band whose slot format being configured as “F” among L1 sub-bands.

### Embodiment 11A

Embodiment 11A illustrates a structure block diagram in a first node, as shown in FIG. 11A. In FIG. 11A, a first node 1100A comprises a first receiver 1101A and a first transceiver 1102A.

The first receiver 1101A receives a first signaling, and the first signaling is used to indicate a first reference signal resource;
the first transceiver 1102A receives a first signal in a first time-frequency resource set, or transmits a first signal in a first time-frequency resource set; the first reference signal resource is used to determine spatial parameters of the first signal;

In embodiment 11A, the first signaling is used to indicate the first time-frequency resource set; the first reference signal resource is one of K1 candidate reference signal resources, K1 is a positive integer greater than 1, and the first signaling indicates the first reference signal resource from the K1 candidate reference signal resources; a target reference signal resource set comprises K1 candidate reference signal resources, and the target reference signal resource set is one of M1 reference signal resource sets, where M1 is a positive integer greater than 1; time-domain resources occupied by the first time-frequency resource set are used to determine the target reference signal resource set from the M1 reference signal resource sets.

In one embodiment, the M1 reference signal resource sets comprise a first reference signal resource set and a second reference signal resource set, and time-domain resources occupied by the first time-frequency resource set comprise a first symbol set; when a format adopted by a symbol in the first symbol set is a first format, the target reference signal resource set is the first reference signal resource set; when a format adopted by a symbol in the first symbol set is a second format, the target reference signal resource set is the second reference signal resource set; the first format and the second format are different.

In one embodiment, the M1 reference signal resource sets comprise a first reference signal resource set and a second reference signal resource set, and time-domain resources occupied by the first time-frequency resource set belongs to a first time unit; when the first time unit is a time unit in a first time unit set, the target reference signal resource set is the first reference signal resource set; when the first time unit is a time unit in a second time unit set, the target reference signal resource set is the second reference signal resource set; a format of any time unit in the first time unit set is different from a format of any time unit in the second time unit set.

In one embodiment, the first receiver 1101A receives a first information block; the first information block is used to indicate a format adopted by a symbol comprised in the time-domain resources occupied by the first time-frequency resource set.

In one embodiment, the first receiver 1101A receives a second information block; the second information block is used to indicate the M1 reference signal resource sets.

In one embodiment, transmit power of the first signal is equal to a first power value, the first power value is not greater than a first threshold, the first threshold is one of M2 candidate thresholds, time-domain resources occupied by the first time-frequency resource set are used to determine the first threshold from the M2 candidate thresholds; M2 is a positive integer greater than 1.

In one embodiment, transmit power of the first signal is equal to a first power value, the first power value is linearly correlated with a target power value, the target power value is equal to one of M3 candidate power values, and time-domain resources occupied by the first time-frequency resource set are used to determine the target power value from the M3 candidate power values, M3 is a positive integer greater than 1.

In one embodiment, the first receiver 1101A comprises at least first four of the antenna 452, the receiver 454, the multi-antenna receiving processor 458, the receiving processor 456 and the controller/processor 459 in Embodiment 4.

In one embodiment, the first transceiver 1102A comprises at least first six of the antenna 452, the receiver/transmitter 454, the multi-antenna receiving processor 458, the multi-antenna transmitting processor 457, the receiving processor 456, the transmitting processor 468, and the controller/processor 459 in Embodiment 4.

In one embodiment, the first signaling is a PDCCH, the first signal is a PDSCH, and formats of symbols comprised in time-domain resources occupied by the first time-frequency resource set are used to determine the target reference signal resource set from the M1 reference signal resource sets.

In one embodiment, the first signaling is a PDCCH, the first signal is a PDSCH, and formats of symbols comprised in time-domain resources occupied by the first time-frequency resource set are used to determine a transmit power value of the first signal.

In one embodiment, the first signaling is a PDCCH, the first signal is a PUSCH, and formats of symbols comprised in time-domain resources occupied by the first time-frequency resource set are used to determine the target reference signal resource set from the M1 reference signal resource sets.

In one embodiment, the first signaling is a PDCCH, the first signal is a PUSCH, and formats of symbols comprised in time-domain resources occupied by the first time-frequency resource set are used to determine a transmit power value of the first signal.

In one subembodiment of the above four embodiments, the meaning of the phrase of formats of symbols comprised in the occupied time-domain resources comprises: formats of all symbols comprised in occupied time-domain resources.

In one subembodiment of the above four embodiments, the meaning of the phrase of formats of symbols comprised in the occupied time-domain resources comprises: a format of any symbol comprised in occupied time-domain resources.

In one subembodiment of the above four embodiments, the meaning of the phrase of formats of symbols comprised in the occupied time-domain resources comprises: a format of at least one symbol comprised in occupied time-domain resources.

In one subembodiment of the above four embodiments, formats of all symbols comprised in the occupied time-domain resources are the same.

### Embodiment 11B

Embodiment 11B illustrates a schematic diagram of a slot format of a target sub-band, as shown in FIG. 11B. In FIG. 11B, each solid-line-framed rectangle represents time-frequency resources occupied by a slot in the target sub-band, each reticle-filled rectangle represents at least one downlink (D) time-domain symbol, each crossline-filled rectangle represents at least one uplink (U) time-domain symbol, and each unfilled rectangle represents at least one flexible (F) time-domain symbol.

In one embodiment, the scenario shown in the figure is where the target sub-band is configured as variable duplex link direction.

In one embodiment, the scenario shown in the figure is where the target sub-band is configured as flexible link direction.

In one embodiment, the scenario shown in the figure is where the target sub-band is configured as “F”.

### Embodiment 12A

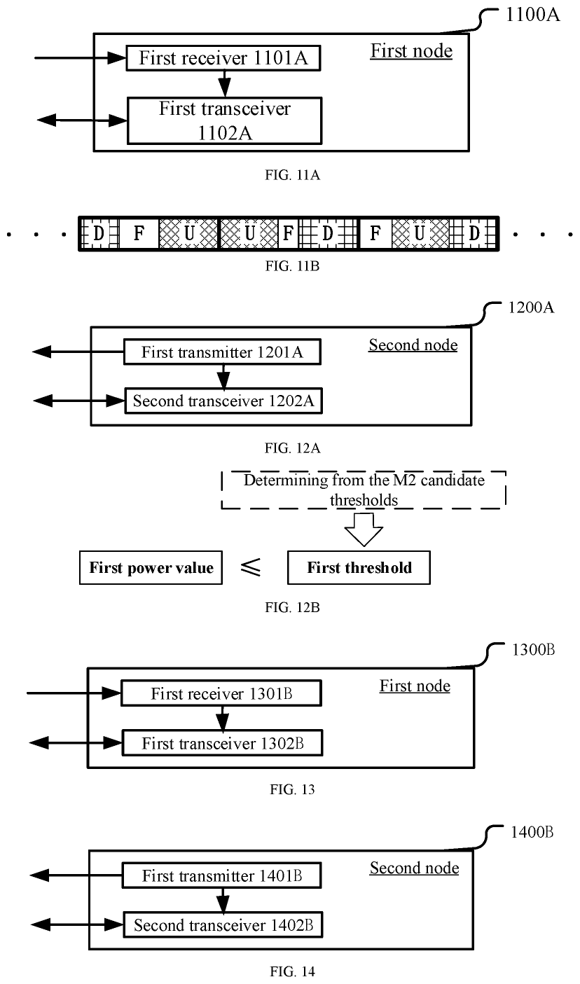

Embodiment 12A illustrates a structure block diagram of in a second node, as shown in FIG. 12A. In FIG. 12A, a second node 1200A comprises a first transmitter 1201A and a second transceiver 1202A.

The first transmitter 1201A transmits a first signaling, and the first signaling is used to indicate a first reference signal resource;
the second transceiver 1202A transmits a first signal in a first time-frequency resource set, or receives a first signal in a first time-frequency resource set; the first reference signal resource is used to determine spatial parameters of the first signal.

In embodiment 12A, the first signaling is used to indicate the first time-frequency resource set; the first reference signal resource is one of K1 candidate reference signal resources, K1 is a positive integer greater than 1, and the first signaling indicates the first reference signal resource from the K1 candidate reference signal resources; a target reference signal resource set comprises K1 candidate reference signal resources, and the target reference signal resource set is one of M1 reference signal resource sets, where M1 is a positive integer greater than 1; time-domain resources occupied by the first time-frequency resource set are used to determine the target reference signal resource set from the M1 reference signal resource sets.

In one embodiment, the M1 reference signal resource sets comprise a first reference signal resource set and a second reference signal resource set, and time-domain resources occupied by the first time-frequency resource set comprise a first symbol set; when a format adopted by a symbol in the first symbol set is a first format, the target reference signal resource set is the first reference signal resource set; when a format adopted by a symbol in the first symbol set is a second format, the target reference signal resource set is the second reference signal resource set; the first format and the second format are different.

In one embodiment, the M1 reference signal resource sets comprise a first reference signal resource set and a second reference signal resource set, and time-domain resources occupied by the first time-frequency resource set belongs to a first time unit; when the first time unit is a time unit in a first time unit set, the target reference signal resource set is the first reference signal resource set; when the first time unit is a time unit in a second time unit set, the target reference signal resource set is the second reference signal resource set; a format of any time unit in the first time unit set is different from a format of any time unit in the second time unit set.

In one embodiment, the first transmitter 1201A transmits a first information block; the first information block is used to indicate a format adopted by a symbol comprised in the time-domain resources occupied by the first time-frequency resource set.

In one embodiment, the first transmitter 1201A transmits a second information block; the second information block is used to indicate the M1 reference signal resource sets.

In one embodiment, transmit power of the first signal is equal to a first power value, the first power value is not greater than a first threshold, the first threshold is one of M2 candidate thresholds, time-domain resources occupied by the first time-frequency resource set are used to determine the first threshold from the M2 candidate thresholds; M2 is a positive integer greater than 1.

In one embodiment, transmit power of the first signal is equal to a first power value, the first power value is linearly correlated with a target power value, the target power value is equal to one of M3 candidate power values, and time-domain resources occupied by the first time-frequency resource set are used to determine the target power value from the M3 candidate power values, M3 is a positive integer greater than 1.

In one embodiment, the first transmitter 1201A comprises at least first four of the antenna 420, the transmitter 418, the multi-antenna transmitting processor 471, the transmitting processor 414 and the controller/processor 475 in Embodiment 4.

In one embodiment, the second transceiver 1202A comprises at least first six of the antenna 420, the transmitter/receiver 418, the multi-antenna transmitting processor 471, the multi-antenna receiving processor 472, the transmitting processor 416, the receiving processor 470, and the controller/processor 475 in Embodiment 4.

In one embodiment, the first signaling is a PDCCH, the first signal is a PDSCH, and formats of symbols comprised in time-domain resources occupied by the first time-frequency resource set are used to determine the target reference signal resource set from the M1 reference signal resource sets.

In one embodiment, the first signaling is a PDCCH, the first signal is a PDSCH, and formats of symbols comprised in time-domain resources occupied by the first time-frequency resource set are used to determine a transmit power value of the first signal.

In one embodiment, the first signaling is a PDCCH, the first signal is a PUSCH, and formats of symbols comprised in time-domain resources occupied by the first time-frequency resource set are used to determine the target reference signal resource set from the M1 reference signal resource sets.

In one embodiment, the first signaling is a PDCCH, the first signal is a PUSCH, and formats of symbols comprised in time-domain resources occupied by the first time-frequency resource set are used to determine a transmit power value of the first signal.

In one subembodiment of the above four embodiments, the meaning of the phrase of formats of symbols comprised in the occupied time-domain resources comprises: formats of all symbols comprised in occupied time-domain resources.

In one subembodiment of the above four embodiments, the meaning of the phrase of formats of symbols comprised in the occupied time-domain resources comprises: a format of any symbol comprised in occupied time-domain resources.

In one subembodiment of the above four embodiments, the meaning of the phrase of formats of symbols comprised in the occupied time-domain resources comprises: a format of at least one symbol comprised in occupied time-domain resources.

In one subembodiment of the above four embodiments, formats of all symbols comprised in the occupied time-domain resources are the same.

### Embodiment 12B

Embodiment 12B illustrates a schematic diagram of a first power value, as shown in FIG. 12B. In embodiment 12B, transmit power of the first signal is equal to a first power value, the first power value is not greater than a first threshold, the first threshold is one of M2 candidate thresholds, and at least one of a relation between the first time-frequency resource set and the target sub-band or configuration information of the target sub-band is used to determine the first threshold from the M2 candidate thresholds; M2 is a positive integer greater than 1.

In one embodiment, a value of the M2 is equal to a value of the M1 in the present application.

In one embodiment, the first power value is measured by dBm.

In one embodiment, the first power value is measured by milliwatt.

In one embodiment, the first threshold is measured by dBm.

In one embodiment, the first threshold is measured by milliwatts.

In one embodiment, the first threshold is P_{CMAX,f,c} in TS38.213.

In one embodiment, the first threshold is used to determine P_{CMAX,f,c} in TS38.213.

In one embodiment, the first threshold is P_{CMAX_H,f,c} in TS38.101.

In one embodiment, M2 is equal to 2, and the M2 candidate thresholds are respectively a first candidate threshold and a second candidate threshold; when the target reference signal resource set is the first reference signal resource set, the first threshold is the first candidate threshold; when the target reference signal resource set is the second reference signal resource set, the first threshold is the second candidate threshold.

In one embodiment, M2 is equal to 2, and the M2 candidate thresholds are respectively a third candidate threshold and a fourth candidate threshold; when the target reference signal resource set is the third reference signal resource set, the first threshold is the third candidate threshold; when the target reference signal resource set is the fourth reference signal resource set, the first threshold is the fourth candidate threshold.

In one embodiment, M4 is equal to 4, and the M2 candidate thresholds are respectively a first candidate threshold, a second candidate threshold, a third candidate threshold, and a fourth candidate threshold; when the target reference signal resource set is the first reference signal resource set, the first threshold is the first candidate threshold; when the target reference signal resource set is the second reference signal resource set, the first threshold is the second candidate threshold; when the target reference signal resource set is the third reference signal resource set, the first threshold is the third candidate threshold; when the target reference signal resource set is the fourth reference signal resource set, the first threshold is the fourth candidate threshold.

### Embodiment 13

Embodiment 13 illustrates a structure block diagram in a first node, as shown in FIG. 13. In FIG. 13, a first node 1300B comprises a first receiver 1301B and a first transceiver 1302B.

The first receiver 1301B receives a first information block and a first signaling, the first information block comprises configuration information of a target sub-band, configuration information of the target sub-band is used to at least determine a slot format for the target sub-band, and the first signaling is used to determine a first time-frequency resource set and a first reference signal resource;
the first transceiver 1302B receives a first signal in the first time-frequency resource set, transmits a first signal in the first time-frequency resource set, and the first reference signal resource is used to determine spatial parameters of the first signal;
in embodiment 13B, the first time-frequency resource set comprises at least one resource block in frequency domain and at least one symbol in time domain; the first reference signal resource is one of K1 candidate reference signal resources, K1 is a positive integer greater than 1, and the first signaling indicates the first reference signal resource from the K1 candidate reference signal resources; a target reference signal resource set comprises K1 candidate reference signal resources, and the target reference signal resource set is one of M1 reference signal resource sets, where M1 is a positive integer greater than 1; at least one of a relation between the first time-frequency resource set and the target sub-band, or configuration information of the target sub-band is used to determine the target reference signal resource set from the M1 reference signal resource sets; frequency-domain resources occupied by the first time-frequency resource set and the target sub-band belong to a same BWP.

In one embodiment, a first boundary frequency is equal to a lowest boundary frequency of the target sub-band, and a second boundary frequency is equal to a highest boundary frequency of the target sub-band; a first reference frequency is equal to a difference value in an interval length between the first boundary frequency and a target frequency, and a second reference frequency is equal to a sum of an interval length between a second boundary frequency and the target frequency; a first frequency interval is a frequency interval between the first boundary frequency and the first reference frequency, and a second frequency interval is a frequency interval from the second reference frequency to the second boundary frequency; a location relation between the first time-frequency resource set in frequency domain and the first frequency interval, or a location relation between the second frequency intervals, is used to determine the target reference signal resource set from the M1 reference signal resource sets.

In one embodiment, configuration information of the target sub-band comprises at least one of location information of the target sub-band in frequency domain or a link direction indication of the target sub-band; when configuration information of the target sub-band comprises a link direction indication of the target sub-band, a link direction indication of the target sub-band is used to determine a slot format for the target sub-band.

In one embodiment, the M1 reference signal resource sets comprise a first reference signal resource set and a second reference signal resource set; the first node receives a first signal in the first time-frequency resource set; when there exists an overlapping between the first time-frequency resource set and the first frequency interval or the second frequency interval in frequency domain, and a link direction of the target sub-band is flexible or variable, the target reference signal resource set is the first reference signal resource set; when there does not exist an overlapping between the first time-frequency resource set and any of the first frequency interval or the second frequency interval in frequency domain, the target reference signal resource set is the second reference signal resource set.

In one embodiment, the M1 reference signal resource sets comprise a third reference signal resource set and a fourth reference signal resource set; the first node transmits a first signal in the first time-frequency resource set; when there exists an overlapping between the first time-frequency resource set and the first frequency interval or the second frequency interval in frequency domain, and a link direction of the target sub-band is flexible or variable, the target reference signal resource set is the third reference signal resource set; when there does not exist an overlapping between the first time-frequency resource set and any of the first frequency interval or the second frequency interval in frequency domain, the target reference signal resource set is the fourth reference signal resource set.

In one embodiment, the first receiver 1301B receives a second information block; the second information block is used to indicate the M1 reference signal resource sets.

In one embodiment, transmit power of the first signal is equal to a first power value, the first power value is not greater than a first threshold, the first threshold is one of M2 candidate thresholds, and at least one of a relation between the first time-frequency resource set and the target sub-band or configuration information of the target sub-band is used to determine the first threshold from the M2 candidate thresholds; M2 is a positive integer greater than 1.

In one embodiment, the first receiver 1301B comprises at least first four of the antenna 452, the receiver 454, the multi-antenna receiving processor 458, the receiving processor 456 and the controller/processor 459 in Embodiment 4.

In one embodiment, the first transceiver 1302B comprises at least first six of the antenna 452, the receiver/transmitter 454, the multi-antenna receiving processor 458, the multi-antenna transmitting processor 457, the receiving processor 456, the transmitting processor 468, and the controller/processor 459 in Embodiment 4.

In one embodiment, the first information block is carried by an RRC signaling, the first signaling is a PDCCH, the first signal is a PDSCH or a PUSCH, a relation between the first time-frequency resource set and the target sub-band is used to determine the target reference signal resource set from the M1 reference signal resource sets, and the frequency-domain resources occupied by the first time-frequency resource set and the target sub-band belong to a same BWP.

In one embodiment, the first information block is carried by a MAC CE signaling, the first signaling is a PDCCH, the first signal is a PDSCH or a PUSCH, a relation between the first time-frequency resource set and the target sub-band is used to determine the target reference signal resource set from the M1 reference signal resource sets, and the frequency-domain resources occupied by the first time-frequency resource set and the target sub-band belong to a same BWP.

In one embodiment, the first information block is carried by an RRC signaling, the first signaling is a PDCCH, the first signal is a PDSCH or a PUSCH, configuration information of the target sub-band is used to determine the target reference signal resource set from the M1 reference signal resource sets, and the frequency-domain resources occupied by the first time-frequency resource set and the target sub-band belong to a same BWP.

In one embodiment, the first information block is carried by a MAC CE signaling, the first signaling is a PDCCH, the first signal is a PDSCH or a PUSCH, configuration information of the target sub-band is used to determine the target reference signal resource set from the M1 reference signal resource sets, and the frequency-domain resources occupied by the first time-frequency resource set and the target sub-band belong to a same BWP.

In one embodiment, the first information block is carried by an RRC signaling, the first signaling is a PDCCH, the first signal is a PDSCH or a PUSCH, a relation between the first time-frequency resource set and the target sub-band as well as configuration information of the target sub-band are used together to determine the target reference signal resource set from the M1 reference signal resource sets, and the frequency-domain resources occupied by the first time-frequency resource set and the target sub-band belong to a same BWP.

In one embodiment, the first information block is carried by a MAC CE signaling, the first signaling is a PDCCH, the first signal is a PDSCH or a PUSCH, a relation between the first time-frequency resource set and the target sub-band as well as configuration information of the target sub-band are used together to determine the target reference signal resource set from the M1 reference signal resource sets, and the frequency-domain resources occupied by the first time-frequency resource set and the target sub-band belong to a same BWP.

### Embodiment 14

Embodiment 14 illustrates a structure block diagram of in a second node, as shown in FIG. 14. In FIG. 14, a second node 1400B comprises a first transmitter 1401B and a second transceiver 1402B.

The first transmitter 1401B transmits a first information block and a first signaling, the first information block comprises configuration information of a target sub-band, configuration information of the target sub-band is used to at least determine a slot format for the target sub-band, and the first signaling is used to determine a first time-frequency resource set and a first reference signal resource;
the second transceiver 1402B transmits a first signal in the first time-frequency resource set, or receives a first signal in the first time-frequency resource set, and the first reference signal resource is used to determine spatial parameters of the first signal;

In embodiment 14B, the first time-frequency resource set comprises at least one resource block in frequency domain and at least one symbol in time domain; the first reference signal resource is one of K1 candidate reference signal resources, K1 is a positive integer greater than 1, and the first signaling indicates the first reference signal resource from the K1 candidate reference signal resources; a target reference signal resource set comprises K1 candidate reference signal resources, and the target reference signal resource set is one of M1 reference signal resource sets, where M1 is a positive integer greater than 1; at least one of a relation between the first time-frequency resource set and the target sub-band, or configuration information of the target sub-band is used to determine the target reference signal resource set from the M1 reference signal resource sets; frequency-domain resources occupied by the first time-frequency resource set and the target sub-band belong to a same BWP.

In one embodiment, a first boundary frequency is equal to a lowest boundary frequency of the target sub-band, and a second boundary frequency is equal to a highest boundary frequency of the target sub-band; a first reference frequency is equal to a difference value in an interval length between the first boundary frequency and a target frequency, and a second reference frequency is equal to a sum of an interval length between a second boundary frequency and the target frequency; a first frequency interval is a frequency interval between the first boundary frequency and the first reference frequency, and a second frequency interval is a frequency interval from the second reference frequency to the second boundary frequency; a location relation between the first time-frequency resource set in frequency domain and the first frequency interval, or a location relation between the second frequency intervals, is used to determine the target reference signal resource set from the M1 reference signal resource sets.

In one embodiment, configuration information of the target sub-band comprises at least one of location information of the target sub-band in frequency domain or a link direction indication of the target sub-band; when configuration information of the target sub-band comprises a link direction indication of the target sub-band, a link direction indication of the target sub-band is used to determine a slot format for the target sub-band.

In one embodiment, the M1 reference signal resource sets comprise a first reference signal resource set and a second reference signal resource set; the second node transmits a first signal in the first time-frequency resource set; when there exists an overlapping between the first time-frequency resource set and the first frequency interval or the second frequency interval in frequency domain, and a link direction of the target sub-band is flexible or variable, the target reference signal resource set is the first reference signal resource set; when there does not exist an overlapping between the first time-frequency resource set and any of the first frequency interval or the second frequency interval in frequency domain, the target reference signal resource set is the second reference signal resource set.

In one embodiment, the M1 reference signal resource sets comprise a third reference signal resource set and a fourth reference signal resource set; the second node receives a first signal in the first time-frequency resource set; when there exists an overlapping between the first time-frequency resource set and the first frequency interval or the second frequency interval in frequency domain, and a link direction of the target sub-band is flexible or variable, the target reference signal resource set is the third reference signal resource set; when there does not exist an overlapping between the first time-frequency resource set and any of the first frequency interval or the second frequency interval in frequency domain, the target reference signal resource set is the fourth reference signal resource set.

In one embodiment, the first transmitter 1401B transmits a second information block; the second information block is used to indicate the M1 reference signal resource sets.

In one embodiment, transmit power of the first signal is equal to a first power value, the first power value is not greater than a first threshold, the first threshold is one of M2 candidate thresholds, and at least one of a relation between the first time-frequency resource set and the target sub-band or configuration information of the target sub-band is used to determine the first threshold from the M2 candidate thresholds; M2 is a positive integer greater than 1.

In one embodiment, the first transmitter 1401B comprises at least first four of the antenna 420, the transmitter 418, the multi-antenna transmitting processor 471, the transmitting processor 414 and the controller/processor 475 in embodiment 4.

In one embodiment, the second transceiver 1402B comprises at least first six of the antenna 420, the transmitter/receiver 418, the multi-antenna transmitting processor 471, the multi-antenna receiving processor 472, the transmitting processor 416, the receiving processor 470, and the controller/processor 475 in Embodiment 4.

In one embodiment, the first information block is carried by an RRC signaling, the first signaling is a PDCCH, the first signal is a PDSCH or a PUSCH, a relation between the first time-frequency resource set and the target sub-band is used to determine the target reference signal resource set from the M1 reference signal resource sets, and the frequency-domain resources occupied by the first time-frequency resource set and the target sub-band belong to a same BWP.

In one embodiment, the first information block is carried by a MAC CE signaling, the first signaling is a PDCCH, the first signal is a PDSCH or a PUSCH, a relation between the first time-frequency resource set and the target sub-band is used to determine the target reference signal resource set from the M1 reference signal resource sets, and the frequency-domain resources occupied by the first time-frequency resource set and the target sub-band belong to a same BWP.

In one embodiment, the first information block is carried by an RRC signaling, the first signaling is a PDCCH, the first signal is a PDSCH or a PUSCH, configuration information of the target sub-band is used to determine the target reference signal resource set from the M1 reference signal resource sets, and the frequency-domain resources occupied by the first time-frequency resource set and the target sub-band belong to a same BWP.

In one embodiment, the first information block is carried by a MAC CE signaling, the first signaling is a PDCCH, the first signal is a PDSCH or a PUSCH, configuration information of the target sub-band is used to determine the target reference signal resource set from the M1 reference signal resource sets, and the frequency-domain resources occupied by the first time-frequency resource set and the target sub-band belong to a same BWP.

In one embodiment, the first information block is carried by an RRC signaling, the first signaling is a PDCCH, the first signal is a PDSCH or a PUSCH, a relation between the first time-frequency resource set and the target sub-band as well as configuration information of the target sub-band are used together to determine the target reference signal resource set from the M1 reference signal resource sets, and the frequency-domain resources occupied by the first time-frequency resource set and the target sub-band belong to a same BWP.

In one embodiment, the first information block is carried by a MAC CE signaling, the first signaling is a PDCCH, the first signal is a PDSCH or a PUSCH, a relation between the first time-frequency resource set and the target sub-band as well as configuration information of the target sub-band are used together to determine the target reference signal resource set from the M1 reference signal resource sets, and the frequency-domain resources occupied by the first time-frequency resource set and the target sub-band belong to a same BWP.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The first node in the present application includes but is not limited to mobile phones, tablet computers, notebooks, network cards, low-consumption equipment, enhanced MTC (eMTC) terminals, NB-IOT terminals, vehicle-mounted communication equipment, vehicles, cars, RSUs, aircrafts, diminutive airplanes, unmanned aerial vehicles, telecontrolled aircrafts and other wireless communication devices. The second node in the present application includes but is not limited to macro-cellular base stations, femtocell, micro-cellular base stations, home base stations, relay base station, eNB, gNB, Transmitter Receiver Point (TRP), GNSS, relay satellites, satellite base stations, space base stations, RSUs, Unmanned Aerial Vehicle (UAV), test devices, for example, a transceiver or a signaling tester simulating some functions of a base station and other radio communication equipment.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first signaling, the first signaling being used to indicate a first reference signal resource; and
a first transceiver, operating a first signal in a first time-frequency resource set, the first reference signal resource being used to determine spatial parameters of the first signal;
wherein the first signaling is used to indicate the first time-frequency resource set; the first reference signal resource is one of K1 candidate reference signal resources, K1 is a positive integer greater than 1, and the first signaling indicates the first reference signal resource from the K1 candidate reference signal resources; a target reference signal resource set comprises K1 candidate reference signal resources, and the target reference signal resource set is one of M1 reference signal resource sets, where M1 is a positive integer greater than 1; time-domain resources occupied by the first time-frequency resource set are used to determine the target reference signal resource set from the M1 reference signal resource sets; the operating action is receiving, or, the operating action is transmitting.

2. The first node according to claim 1, wherein the M1 reference signal resource sets comprise a first reference signal resource set and a second reference signal resource set, and time-domain resources occupied by the first time-frequency resource set comprise a first symbol set; when a format adopted by a symbol in the first symbol set is a first format, the target reference signal resource set is the first reference signal resource set; when a format adopted by a symbol in the first symbol set is a second format, the target reference signal resource set is the second reference signal resource set; the first format and the second format are different.

3. The first node according to claim 1, wherein the M1 reference signal resource sets comprise a first reference signal resource set and a second reference signal resource set, and time-domain resources occupied by the first time-frequency resource set belong to a first symbol set; when the first time unit is a time unit in a first time unit set, the target reference signal resource set is the first reference signal resource set; when the first time unit is a time unit in a second time unit set, the target reference signal resource set is the second reference signal resource set; a format of any time unit in the first time unit set is different from a format of any time unit in the second time unit set.

4. The first node according to claim 1, wherein the first receiver receives a first information block; the first information block is used to indicate a format adopted by a symbol comprised in the time-domain resources occupied by the first time-frequency resource set.

5. The first node according to claim 1, wherein the first receiver receives a second information block; the second information block is used to indicate the M1 reference signal resource sets.

6. The first node according to claim 1, wherein transmit power of the first signal is equal to a first power value, the first power value is not greater than a first threshold, the first threshold is one of M2 candidate thresholds, time-domain resources occupied by the first time-frequency resource set are used to determine the first threshold from the M2 candidate thresholds; M2 is a positive integer greater than 1.

7. The first node according to claim 1, wherein transmit power of the first signal is equal to a first power value, the first power value is linearly correlated with a target power value, the target power value is equal to one of M3 candidate power values, and time-domain resources occupied by the first time-frequency resource set are used to determine the target power value from the M3 candidate power values; the M3 is a positive integer greater than 1.

8. A second node for wireless communications, comprising:
a first transmitter, transmitting a first signaling, the first signaling being used to indicate a first reference signal resource; and
a second transceiver, executing a first signal in a first time-frequency resource set, the first reference signal resource being used to determine spatial parameters of the first signal;
wherein the first signaling is used to indicate the first time-frequency resource set; the first reference signal resource is one of K1 candidate reference signal resources, K1 is a positive integer greater than 1, and the first signaling indicates the first reference signal resource from the K1 candidate reference signal resources; a target reference signal resource set comprises K1 candidate reference signal resources, and the target reference signal resource set is one of M1 reference signal resource sets, where M1 is a positive integer greater than 1; time-domain resources occupied by the first time-frequency resource set are used to determine the target reference signal resource set from the M1 reference signal resource sets; the executing action is transmitting, or the executing action is receiving.

9. The second node according to claim 8, wherein the M1 reference signal resource sets comprise a first reference signal resource set and a second reference signal resource set, and time-domain resources occupied by the first time-frequency resource set comprise a first symbol set; when a format adopted by a symbol in the first symbol set is a first format, the target reference signal resource set is the first reference signal resource set; when a format adopted by a symbol in the first symbol set is a second format, the target reference signal resource set is the second reference signal resource set; the first format and the second format are different.

10. The second node according to claim 8, wherein the M1 reference signal resource sets comprise a first reference signal resource set and a second reference signal resource set, and time-domain resources occupied by the first time-frequency resource set belong to a first symbol set; when the first time unit is a time unit in a first time unit set, the target reference signal resource set is the first reference signal resource set; when the first time unit is a time unit in a second time unit set, the target reference signal resource set is the second reference signal resource set; a format of any time unit in the first time unit set is different from a format of any time unit in the second time unit set.

11. The second node according to claim 8, wherein the first transmitter transmits a first information block; the first information block is used to indicate a format adopted by a symbol comprised in the time-domain resources occupied by the first time-frequency resource set.

12. The second node according to claim 8, wherein the first transmitter transmits a second information block; the second information block is used to indicate the M1 reference signal resource sets.

13. The second node according to claim 8, wherein transmit power of the first signal is equal to a first power value, the first power value is not greater than a first threshold, the first threshold is one of M2 candidate thresholds, time-domain resources occupied by the first time-frequency resource set are used to determine the first threshold from the M2 candidate thresholds; M2 is a positive integer greater than 1.

14. The second node according to claim 8, wherein transmit power of the first signal is equal to a first power value, the first power value is linearly correlated with a target power value, the target power value is equal to one of M3 candidate power values, and time-domain resources occupied by the first time-frequency resource set are used to determine the target power value from the M3 candidate power values; the M3 is a positive integer greater than 1.

15. A method in a first node for wireless communications, comprising:
receiving a first signaling, the first signaling being used to indicate a first reference signal resource; and
operating a first signal in a first time-frequency resource set, the first reference signal resource being used to determine spatial parameters of the first signal;
wherein the first signaling is used to indicate the first time-frequency resource set; the first reference signal resource is one of K1 candidate reference signal resources, K1 is a positive integer greater than 1, and the first signaling indicates the first reference signal resource from the K1 candidate reference signal resources; a target reference signal resource set comprises K1 candidate reference signal resources, and the target reference signal resource set is one of M1 reference signal resource sets, where M1 is a positive integer greater than 1; time-domain resources occupied by the first time-frequency resource set are used to determine the target reference signal resource set from the M1 reference signal resource sets; the operating action is receiving, or, the operating action is transmitting.

16. The method in a first node according to claim 15, wherein the M1 reference signal resource sets comprise a first reference signal resource set and a second reference signal resource set, and time-domain resources occupied by the first time-frequency resource set comprise a first symbol set; when a format adopted by a symbol in the first symbol set is a first format, the target reference signal resource set is the first reference signal resource set;
when a format adopted by a symbol in the first symbol set is a second format, the target reference signal resource set is the second reference signal resource set; the first format and the second format are different.

17. The method in a first node according to claim 15, wherein the M1 reference signal resource sets comprise a first reference signal resource set and a second reference signal resource set, and time-domain resources occupied by the first time-frequency resource set belong to a first symbol set; when the first time unit is a time unit in a first time unit set, the target reference signal resource set is the first reference signal resource set; when the first time unit is a time unit in a second time unit set, the target reference signal resource set is the second reference signal resource set; a format of any time unit in the first time unit set is different from a format of any time unit in the second time unit set.

18. The method in a first node according to claim 15, wherein the first receiver receives a first information block; the first information block is used to indicate a format adopted by a symbol comprised in the time-domain resources occupied by the first time-frequency resource set.

19. The method in a first node according to claim 15, wherein the first receiver receives a second information block; the second information block is used to indicate the M1 reference signal resource sets.

20. The method in a first node according to claim 15, wherein transmit power of the first signal is equal to a first power value, the first power value is not greater than a first threshold, the first threshold is one of M2 candidate thresholds, time-domain resources occupied by the first time-frequency resource set are used to determine the first threshold from the M2 candidate thresholds; M2 is a positive integer greater than 1.
